(19) United States
(12) Patent Application Publication
(10) Pub. No.: US 2019/0108522 A1
(43) Pub. Date: Apr. 11, 2019

(54) INFORMATION PROCESSING APPARATUS, MANAGEMENT APPARATUS, INFORMATION PROCESSING METHOD, AND INFORMATION PROCESSING SYSTEM

(71) Applicant: FELICA NETWORKS, INC., TOKYO (JP)

(72) Inventor: SATOSHI YUI, KANAGAWA (JP)

(21) Appl. No.: 16/087,516

(22) PCT Filed: Jan. 23, 2017
(86) PCT No.: PCT/JP2017/002182

§ 371 Date: Sep. 21, 2018

(30) Foreign Application Priority Data
Mar. 30, 2016 (JP) 2016-069356

(51) Int. Cl. G06Q 20/40; G06Q 20/24

(52) U.S. Cl. CPC G06Q 20/405; G06Q 20/24

(57) ABSTRACT

Provided is an information processing apparatus including: a condition information acquiring unit configured to acquire condition information indicating a use condition of an electronic value transferred from a transfer source; and a processing unit configured to determine whether or not the transferred electronic value is usable on a basis of the condition information and control a function related to use of the transferred electronic value on a basis of a determination result.

### TECHNICAL FIELD

The present disclosure relates to an information processing apparatus, a management apparatus, an information processing method, and an information processing system.

### BACKGROUND ART

Techniques related to transfer of an electronic value (money or data having a value equivalent to money; the same applies hereinafter) between apparatuses are being developed. As a technique related to transfer of an electronic value from a transmission source terminal to a transmission destination terminal, there is, for example, the technique described in Patent Literature 1.

Further, techniques of restricting the use of electronic values are being developed. As a technique of determining whether or not a use state of electronic money (an example of an electronic value) is within a set usable range and restricting the use of the electronic money in a case in which the use state of electronic money is outside the usable range, there is, for example, the technique disclosed in Patent Literature 2.

### CITATION LIST

### Patent Literature

Patent Literature 1 JP 2006-155045A

Patent Literature 2 JP 2008-269292A

### DISCLOSURE OF INVENTION

### Technical Problem

There is a need for a technique of restricting the use of a transferred electronic value in a case in which the electronic value is transferred from an apparatus which is a transfer source of the electronic value (an apparatus associated with a transfer source; hereinafter also referred to as a “transfer source” or a “transfer source apparatus”) to an apparatus which is a transfer destination of the electronic value (hereinafter also referred to as a “transfer destination apparatus”).

Here, for example, in the technique described in Patent Literature 2, a terminal apparatus that performs communication related to the use of the electronic value with an apparatus that stores the electronic value determines whether or not the use state of the electronic value is in the set usable range. Then, the terminal apparatus restricts the use of the electronic value in a case in which it is determined that the use state of the electronic value is outside the usable range. Thus, for example, using the technique described in Patent Literature 2, it is possible to restrict the use of the electronic value in the transfer destination apparatus corresponding to the apparatus that stores the electronic value in a case in which the use state of the electronic value is outside the usable range.

However, in a case in which the technique described in Patent Literature 2 is used, for example, the terminal apparatus has to have a function of determining whether or not the use state of the electronic value is within the set usable range. Therefore, for example, in a case in which a payment-related apparatus installed in a store that supports payment using an electronic value or the like does not have the function of determining whether or not the use state of the electronic value is within the set usable range, the use of the transferred electronic value in the transfer destination apparatus is unable to be restricted.

The present disclosure proposes an information processing apparatus, a management apparatus, an information processing method, and an information processing system which are novel and improved and capable of controlling the use of electronic values transferred from a transfer source.

### Solution to Problem

According to the present disclosure, there is provided an information processing apparatus including: a condition information acquiring unit configured to acquire condition information indicating a use condition of an electronic value transferred from a transfer source; and a processing unit configured to determine whether or not the transferred electronic value is usable on a basis of the condition information and control a function related to use of the transferred electronic value on a basis of a determination result.

In addition, according to the present disclosure, there is provided a management apparatus configured to perform communication with an information processing apparatus to which an electronic value is transferred from an apparatus associated with a transfer source, and cause the information processing apparatus to set condition information indicating a use condition of the electronic value transferred from the apparatus associated with the transfer source.

In addition, according to the present disclosure, there is provided an information processing method that is executed by an information processing apparatus, the information processing method including: a step of acquiring condition information indicating a use condition of an electronic value transferred from a transfer source; and a step of determining whether or not the transferred electronic value is usable on a basis of the condition information and controlling a function related to use of the transferred electronic value on a basis of a determination result.

In addition, according to the present disclosure, there is provided an information processing system including: a first information processing apparatus which is a transfer source of an electronic value; and a second information processing apparatus which is a transfer destination of the electronic value. The second information processing apparatus includes a condition information acquiring unit configured to acquire condition information indicating a use condition of an electronic value transferred from the first information processing apparatus, and a processing unit configured to determine whether or not the transferred electronic value is usable on a basis of the condition information and control a function related to use of the transferred electronic value on a basis of a determination result.

### Advantageous Effects of Invention

According to the present disclosure, it is possible to control the use of the electronic value transferred from the transfer source.

Note that the effects described above are not necessarily limitative. With or in the place of the above effects, there may be achieved any one of the effects described in this specification or other effects that may be grasped from this specification.

### BRIEF DESCRIPTION OF DRAWINGS

FIG. 1 is an explanatory diagram illustrating an example of an information processing system according to the present embodiment to which an information processing method according to the present embodiment can be applied.

FIG. 2 is an explanatory diagram for describing an example of a process related to an information processing method according to the present embodiment.

FIG. 3 is an explanatory diagram for describing an example of a process related to an information processing method according to the present embodiment.

FIG. 4 is an explanatory diagram for describing an example of a process related to an information processing method according to the present embodiment.

FIG. 5 is an explanatory diagram for describing an example of a process related to an information processing method according to the present embodiment.

FIG. 6 is an explanatory diagram for describing an example of a process related to an information processing method according to the present embodiment.

FIG. 7 is an explanatory diagram for describing an example of a process related to an information processing method according to the present embodiment.

FIG. 8 is an explanatory diagram for describing an example of a process related to an information processing method according to the present embodiment.

FIG. 9 is an explanatory diagram for describing an example of a process related to an information processing method according to the present embodiment.

FIG. 10 is an explanatory diagram for describing an example of a process related to an information processing method according to the present embodiment.

FIG. 11 is a block diagram illustrating an example of a configuration of an information processing apparatus according to the present embodiment.

FIG. 12 is an explanatory diagram illustrating an example of a hardware configuration of an information processing apparatus according to the present embodiment.

FIG. 13 is an explanatory diagram illustrating an example of a configuration of an IC chip and an antenna illustrated in FIG. 12.

FIG. 14 is a block diagram illustrating an example of a configuration of an information processing apparatus according to the present embodiment.

FIG. 15 is a block diagram illustrating an example of a configuration of a first management apparatus according to the present embodiment.

FIG. 16 is an explanatory diagram illustrating an example of a hardware configuration of a first management apparatus according to the present embodiment.

FIG. 17 is a block diagram illustrating an example of a configuration of a second management apparatus according to the present embodiment.

### MODE(S) FOR CARRYING OUT THE INVENTION

Hereinafter, (a) preferred embodiment(s) of the present disclosure will be described in detail with reference to the appended drawings. Note that, in this specification and the appended drawings, structural elements that have substantially the same function and structure are denoted with the same reference numerals, and repeated explanation of these structural elements is omitted.

Further, hereinafter, the description will proceed in the following order.
1. Information processing method according to present embodiment
2. Information processing system according to present embodiment
3. Program according to present embodiment

### (Information Processing Method According to Present Embodiment)

First, an information processing method according to the present embodiment will be described.

### [1] Overview of Process Related to Information Processing Method According to Present Embodiment

As described above, as a “method of restricting the use of a transferred electronic value in a case in which the electronic value is transferred from a transfer source apparatus to a transfer destination apparatus,” for example, there is a method in which an apparatus that performs communication related to the use of an electronic value with a transfer destination apparatus determines whether or not the use state of the electronic value is within the set usable range. Hereinafter, an apparatus related to payment using an electronic value such as an apparatus that performs communication related to the use of an electronic value is also referred to as a “payment apparatus.”

However, in order to restrict the use of a transferred electronic value using the above-described method, the payment apparatus has to have the function of determining whether or not the electronic value is usable as described above. Therefore, for example, in a case in which the payment apparatus installed in a store that supports payment using the electronic value does not have the function of determining whether or not the electronic value is usable, the use of the transferred electronic value in the transfer destination apparatus is unable to be restricted.

In this regard, in the information processing method according to the present embodiment, an information processing apparatus corresponding to a transfer destination apparatus (an electronic value transfer destination apparatus) controls the function related to the use of the electronic value.

The information processing apparatus corresponding to the transfer destination apparatus can restrict the use of the transferred electronic value in the information processing apparatus by controlling the function related to the use of the electronic value.

Therefore, the information processing apparatus corresponding to the transfer destination apparatus controls the function related to the use of the electronic value, and thus it is possible to control the use of the electronic value transferred from the transfer source without relying on whether or not the payment apparatus has the function of determining whether or not the electronic value is usable.

Further, as described above, in a case in which an information processing method according to the present embodiment is used, the use of the transferred electronic value is controlled by the information processing apparatus corresponding to the transfer destination apparatus, and thus the payment apparatus need not have the function of determining whether or not the electronic value is usable. Thus, in a case in which the information processing method according to the present embodiment is used, for example, “costs for causing the payment apparatus to support the function of determining whether or not the electronic value is usable” such as a “cost related to an improvement for installing the function of determining whether or not the electronic value is usable in the payment apparatus previously installed in the store” or a “cost for newly introducing the payment apparatus having the function of determining whether or not the electronic value is usable into the store” are not necessary.

[2] Example of Information Processing System to which Information Processing Method According to Present Embodiment can be Applied

Next, an example of an information processing system to which the information processing method according to the present embodiment can be applied will be described.

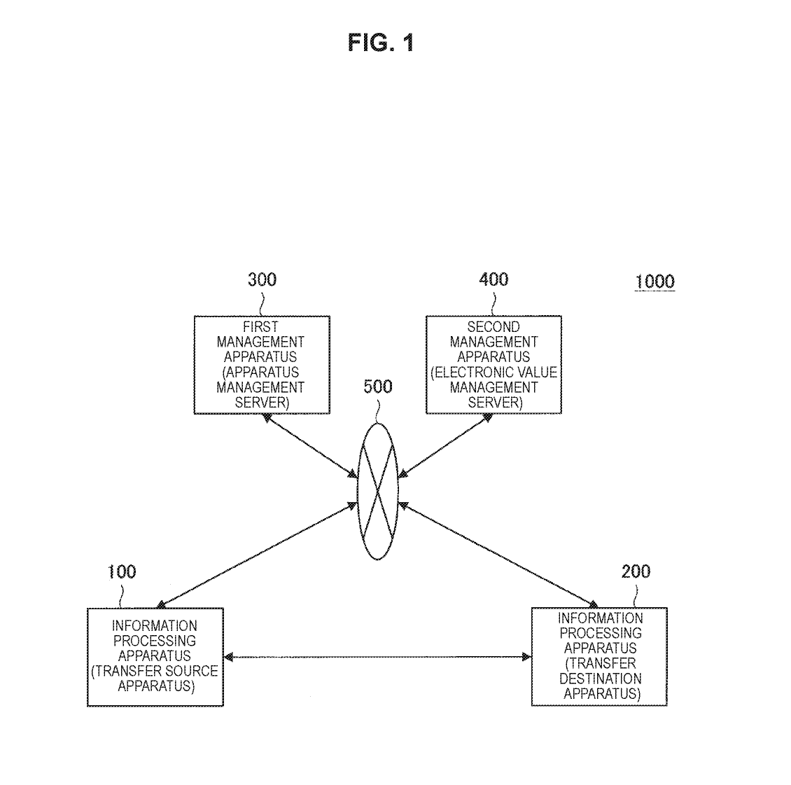

FIG. 1 is an explanatory diagram illustrating an example of an information processing system 1000 according to the present embodiment to which the information processing method according to the present embodiment can be applied.

The information processing system 1000 includes, for example, an information processing apparatus 100, an information processing apparatus 200, a first management apparatus 300, and a second management apparatus 400.

The information processing apparatus 100, the first management apparatus 300, and the second management apparatus 400 communicate with one another via a network 500. Further, the information processing apparatus 200, the first management apparatus 300, and the second management apparatus 400 communicate with one another via the network 500. Examples of the network 500 include a wired network such as a local area network (LAN) or a wide area network (WAN), a wireless network such as a wireless LAN (WLAN), a wireless network according to communication of various communication standards such as 3rd generation (3G) or 4G, and the Internet using a communication protocol such as transmission control protocol/Internet protocol (TCP/IP).

Further, the information processing apparatus 100 and the information processing apparatus 200 can communicate directly with each other by, for example, wireless communication of an arbitrary communication scheme such as non-contact communication, contact communication of an arbitrary communication scheme, or wired communication of an arbitrary communication scheme.

A case in which the information processing apparatus 100 and the information processing apparatus 200 perform non-contact communication by near field communication (NFC) in which communication is performed using a magnetic field (carrier waves) of a predetermined frequency such as 13.56 [MHz] will be described below as an example. Here, in a case in which the information processing apparatus 100 and the information processing apparatus 200 perform communication by NFC, one apparatus serves as a reader/writer (interrogator) in NFC, and the other apparatus serves as a responder in NFC.

Here, a communication coverage of NFC is about 10 [cm]. For this reason, in order to cause the information processing apparatus 100 and the information processing apparatus 200 to communicate with each other by NFC, it is necessary to intentionally move either or both of the information processing apparatus 100 and the information processing apparatus 200 so that both the information processing apparatus 100 and the information processing apparatus 200 are within the communication coverage. Therefore, in a case in which NFC communication is performed between the information processing apparatus 100 and the information processing apparatus 200, it is possible to perform communication on the basis of an intention to cause communication to be performed between the information processing apparatus 100 and the information processing apparatus 200.

Further, in a case in which NFC communication is performed between the information processing apparatus 100 and the information processing apparatus 200, it is possible to perform secure communication as the communication between the information processing apparatus 100 and the information processing apparatus 200.

The information processing apparatus 100 is an apparatus that can be either or both of an electronic value transfer source and an electronic value transfer destination. The case in which the information processing apparatus 100 serves as the electronic value transfer source, that is, the case in which the information processing apparatus 100 functions as the transfer source apparatus, will be mainly described below.

The information processing apparatus 200 is an apparatus that can be either or both of an electronic value transfer source and an electronic value transfer destination. The case in which the information processing apparatus 200 serves as the electronic value transfer destination, that is, the case in which the information processing apparatus 200 functions as the transfer destination apparatus, will be mainly described below.

The first management apparatus 300 is an apparatus that manages an apparatus that functions as either or both of the electronic value transfer source and the electronic value transfer destination such as the information processing apparatus 100 and the information processing apparatus 200. An example of a process related to management of the apparatus in the first management apparatus 300 will be described later.

The first management apparatus 300 may be, for example, a server. Hereinafter, the first management apparatus 300 is also referred to as an “apparatus management server.”

The second management apparatus 400 is an apparatus that manages the electronic value. In the information processing system 1000, the second management apparatus 400 implements the transfer of the electronic value from one apparatus to the other apparatus. An example of a process related to management of the electronic value in the second management apparatus 400 will be described later.

The second management apparatus 400 may be, for example, a server. Hereinafter, the second management apparatus 400 is also referred to as an “electronic value management server.”

For example, the information processing system 1000 has the configuration illustrated in FIG. 1. Further, the information processing system according to the present embodiment is not limited to the example illustrated in FIG. 1.

For example, the first management apparatus 300 and the second management apparatus 400 may be a single apparatus having the function of the first management apparatus 300 and the function of the second management apparatus 400. Further, each of the first management apparatus 300, the second management apparatus 400, the first management apparatus 300, and the second management apparatus 400 may be a group of apparatuses that perform a process in cooperation with a plurality of servers or the like.

Further, each of the first management apparatus 300 and the second management apparatus 400 which communicate with the information processing apparatus 100 and the information processing apparatus 200 via the network 500 may be an external apparatus not included in the information processing system according to the present embodiment.

As described above, the process related to the information processing method according to the present embodiment is performed in the transfer destination apparatus. An example in which, in the information processing system 1000 illustrated in FIG. 1, the information processing apparatus 200 functioning as the transfer destination apparatus performs the process related to the information processing method according to the present embodiment will be described below.

### [3] Process Related to Information Processing Method According to Present Embodiment

Next, the process related to the information processing method according to the present embodiment will be described. In the following description, it is assumed that the information processing method according to the present embodiment is performed by the information processing apparatus 200 functioning as the transfer destination apparatus. Further, in a case in which the information processing apparatus 100 functions as the transfer destination apparatus, the information processing apparatus 100 can perform a process similar to the process in the information processing apparatus 200 to be described later. Further, an example of a process related to the transfer of the electronic value from the transfer source apparatus to the transfer destination apparatus in the information processing system 1000 will be described later.

The information processing apparatus 200 controls the function related to the use of the electronic value on the basis of condition information (a function control process).

The condition information according to the present embodiment is data indicating a use condition of the electronic value transferred from the transfer source apparatus such as the information processing apparatus 100. For example, the condition information is acquired by communication with the first management apparatus 300 that manages the transfer source apparatus and the information processing apparatus 200 and set by the first management apparatus 300 as will be described later. The condition information is acquired, for example, by communication with the first management apparatus 300 being controlled by an acquiring unit (a condition information acquiring unit) to be described later.

An example of the use condition of the transferred electronic value indicated by the condition information will be described later. Further, hereinafter, the use condition of the electronic value transferred from the transfer source apparatus is also referred to simply as a “use condition.”

The information processing apparatus 200 determines whether or not the transferred electronic value is usable on the basis of the condition information, and controls the function related to the use of the electronic value on the basis of the determination result. The information processing apparatus 200 does not restrict the function related to the use of the electronic value in a case in which it is determined that the transferred electronic value is usable. Further, the information processing apparatus 200 restricts the function related to the use of the electronic value in a case in which it is determined that the transferred electronic value is not usable.

Here, as the function related to the use of the electronic value according to the present embodiment, there is, for example, a communication function used for the use of the electronic value (hereinafter also referred to simply as a “communication function”).

As the communication used for the use of the electronic value, for example, NFC is used. Further, the communication used for the use of the electronic value is not limited to NFC. For example, the communication used for using the electronic value may be arbitrary communication through which secure communication can be performed such as wired communication of an arbitrary communication scheme through which secure communication can be performed, wireless communication of an arbitrary communication scheme through which secure communication can be performed, or contact communication of an arbitrary communication scheme through which secure communication can be performed.

As the restriction of the communication function, for example, it is possible to restrict at least a part of the communication function of the information processing apparatus 200. Further, as the restriction of the communication function, for example, it is possible to restrict communication with a predetermined apparatus. For example, the information processing apparatus 200 restricts communication with a predetermined apparatus by not performing a normal response or by performing an error response to a command transmitted from the predetermined apparatus.

Here, the predetermined apparatus related to the restriction of the communication function may be an apparatus that does not have authentication information corresponding to the information processing apparatus 200. The authentication information corresponding to the information processing apparatus 200 is, for example, data used for authentication with the information processing apparatus 200. The authentication information corresponding to the information processing apparatus 200 may be, for example, a password valid between the information processing apparatus 200 and other apparatuses. The authentication information corresponding to the information processing apparatus 200 is generated on the basis of, for example, apparatus information (to be described later) of the information processing apparatus 200. In other words, in a case in which the communication function (an example of the function related to the use of the electronic value) is restricted, the information processing apparatus 200 does not restrict communication with the apparatus having the authentication information corresponding to the information processing apparatus 200 but restricts communication with an apparatus that does not have the authentication information corresponding to the information processing apparatus 200.

Further, the predetermined apparatus related to the restriction of the communication function is not limited to the apparatus that does not have the authentication information corresponding to the information processing apparatus 200. For example, the predetermined apparatus related to the restriction of the communication function may be an apparatus that does not transmit an arbitrary command or arbitrary data set in the information processing apparatus 200 in advance. Hereinafter, a case in which the predetermined apparatus related to the restriction of the communication function is an apparatus in which authentication is not performed by the information processing apparatus 200 will be described as an example.

The information processing apparatus 200 restricts communication with the predetermined apparatus as described above, and thus the restriction of the use of the electronic value transferred from the transfer source apparatus in the information processing apparatus 200 is implemented.

Further, when the function related to the use of the electronic value is restricted, in a case in which communication with the predetermined apparatus is performed, for example, the information processing apparatus 200 cancels the restriction of the function related to the use of the electronic value. Further, in the information processing system 1000, a process of returning the electronic value transferred to the transfer destination apparatus to the transfer source apparatus is performed. An example of the process of returning the transferred electronic value to the transfer source apparatus in the information processing system 1000 will be described later.

A predetermined apparatus related to the cancellation of the restriction of the function may be the apparatus having the authentication information corresponding to the information processing apparatus 200. Further, the predetermined apparatus related to the cancellation of the restriction of the function is not limited to the apparatus having the authentication information corresponding to the information processing apparatus 200. For example, the predetermined apparatus related to the cancellation of the restriction of the function may be an apparatus that transmits an arbitrary command or arbitrary data set in the information processing apparatus 200 in advance. A case in which the predetermined apparatus related to cancellation of the restriction of the function is the apparatus in which authentication is performed by the information processing apparatus 200 will be described as an example.

Further, the function related to the use of the electronic value according to the present embodiment is not limited to the communication function used for the use of the electronic value.

For example, the function related to the use of the electronic value according to the present embodiment may be a function of accessing a recording medium in which the electronic value is recorded. The recording medium in which the electronic value is recorded may be, for example, a secure recording medium having tamper resistance. Further, a secure region and a non-secure region may be mixed in the recording medium in which the electronic value is recorded. For example, the electronic value is stored in the secure recording medium or the secure region of the recording medium to prevent manipulation or theft.

Examples of the access function include a function of reading data from the recording medium and a function of writing data in the recording medium.

When the information processing apparatus 200 restricts the access function to the recording medium in which the electronic value is recorded as described above, reading of data from the recording medium in which the transferred electronic value is stored and writing of data to the recording medium are restricted. Therefore, when the information processing apparatus 200 restricts the access function to the recording medium in which the electronic value is recorded as described above, the restriction of the use of the electronic value transferred from the transfer source apparatus in the information processing apparatus 200 is implemented.

Further, in a case in which the access function is restricted, reading of data from the recording medium and writing of data to the recording medium may not be restricted on the basis of a command from the predetermined apparatus described above.

An example of the function control process according to the present embodiment will be described below together with an example of the use condition of the transferred electronic value indicated by the condition information.

The information processing apparatus 200 performs, for example, any one of the following processes (1) to (5) on each transferred electronic value as the function control process.

(1) First Example of Function Control Process: Example in which use Condition Indicated by Condition Information is Condition Related to Effective Period of Transferred Electronic Value

As the use condition indicated by the condition information, the condition related to the effective period of the transferred electronic value may be used.

As the condition related to the effective period of the transferred electronic value, for example, a condition in which the effective period is specified directly by a date and time, for example, it is valid by “year, month, and date (or year, month, day, and hour, year, month, date, hour, and minute, year, month, date, hour, minute, and second, or the like)” may be used. Further, the condition related to the effective period of the transferred electronic value may be a condition in which the effective period is not specified directly by a date and time, for example, it is valid within a set period after the electronic value is transferred.”

In a case in which the function control process according to the first example, the information processing apparatus 200 determines whether or not the transferred electronic value is usable on the basis of time information and the condition related to the effective period.

The time information according to the present embodiment is, for example, data indicating a time at which determination related to the use condition is performed, that is, data indicating a time at which the electronic value is used. As the time information, for example, data indicating a detection result of a device capable of specifying a time (for example, a date and time) such as a clock of an arbitrary system such as a mechanical type, a quartz type, or a radio type may be used. The device capable of specifying the time may be a device installed in the information processing apparatus 200 or a device outside the information processing apparatus 200. The time information according to the present embodiment is acquired by controlling the device capable of specifying the time through, for example, an acquiring unit (a time information acquiring unit) to be described later.

The information processing apparatus 200 determines whether or not the transferred electronic value is usable, for example, by determining whether or not the effective period elapses when the determination related to the use condition is performed.

As an example, the information processing apparatus 200 determines whether or not the time at which the determination related to the use condition is performed exceeds the effective period, for example, by comparing the time at which the determination related to the use condition is performed with the time specified in the condition related to the effective period of the transferred electronic value.

The information processing apparatus 200 determines that the transferred electronic value is not usable in a case in which it is determined that the effective period elapses. Then, the information processing apparatus 200 restricts the function related to the use of the electronic value as described above.

Further, the information processing apparatus 200 determines that the transferred electronic value is usable in a case in which it is determined that the effective period does not elapse. Then, the information processing apparatus 200 does not restrict the function related to the use of the electronic value.

(2) Second Example of Function Control Process: Example in which use Condition Indicated by Condition Information is Condition Related to Place

As the use condition indicated by the condition information, for example, a condition related to a place in which the transferred electronic value is valid.

As the condition related to the place in which the transferred electronic value is valid, for example, a condition in which the place in which the electronic value is valid is directly specified, for example, “it is valid in a set store,” “it is valid in a set station,” “it is valid in a set facility,” or the like may be used. Further, the condition related the place in which the transferred electronic value is valid may be, a condition in which the place in which the electronic value is valid is vaguely specified, for example, “it is valid within a range of a radius X [km] from a set place,” “it is valid in each of set stations from an A station to a B station,” or the like. Further, the condition related to the place in which the transferred electronic value is valid may be a condition in which the place in which the electronic value is not valid is directly specified, for example, “it is valid outside a set place” or the like.

In a case in which the function control process according to the second example is performed, the information processing apparatus 200 determines whether or not the transferred electronic value is usable on the basis of position information and the condition related to the place.

The position information according to the present embodiment is, for example, data indicating a position related to the information processing apparatus 200. As the position information, for example, data indicating a detection result of a device capable of specifying a position of a global navigation satellite system (GNSS) device or the like (or data indicating an estimation of a device capable of estimating a position by an arbitrary scheme) may be used. The device capable of specifying the position of the GNSS device or the like may be a device installed in the information processing apparatus 200 or a device outside the information processing apparatus 200. The position information according to the present embodiment is acquired by controlling the device capable of specifying a position by, for example, an acquiring unit (a position information acquiring unit) to be described later.

The information processing apparatus 200 determines whether or not the transferred electronic value is usable, for example, by determining whether or not the information processing apparatus 200 is in a valid place indicated by the condition information.

As an example, for example, the information processing apparatus 200 determines whether or not the information processing apparatus 200 is in a valid place indicated by the condition information by comparing a position of the information processing apparatus 200 indicated by the position information with the place specified in the condition related the place in which the transferred electronic value is valid.

The information processing apparatus 200 determines that the transferred electronic value is not usable in a case in which it is determined that the information processing apparatus 200 is not in the valid place. Then, the information processing apparatus 200 restricts the function related to the use of the electronic value as described above.

Further, in a case in which it is determined that the information processing apparatus 200 is in the valid place, the information processing apparatus 200 determines that the transferred electronic value is usable. Then, the information processing apparatus 200 does not restrict the function related to the use of the electronic value.

(3) Third Example of Function Control Process: Example in which use Condition Indicated by Condition Information is Condition Related to Authorized User

The use condition indicated by the condition information may be, for example, a condition related to an authorized user permitted to use the transferred electronic value.

As the condition related to the authorized user permitted to use the transferred electronic value, for example, a condition in which the authorized user who is permitted to use the transferred electronic value is directly specified, for example, “it is valid in a case in which a set user is specified” or the like may be used. Further, the condition related to the authorized user permitted to use the transferred electronic value may be a condition the authorized user who is not permitted to use the transferred electronic value is directly specified is directly specified, for example, “it is valid in a case in which a person other than a set user is specified” or the like.

In a case in which the function control process according to the third example is performed, the information processing apparatus 200 determines whether or not the transferred electronic value is usable on the basis of information related to the user and the condition related to the authorized user.

As the information related to the user according to the present embodiment, for example, data which can be used for specifying the user of information processing apparatus 200 such as data indicating a captured image in which the face of the user of the information processing apparatus 200 is captured, data indicating an iris of the user of the information processing apparatus 200, or data indicating a fingerprint of the user of the information processing apparatus 200 may be used. The information related to the user according to the present embodiment is acquired by controlling a device related to biometric authentication through, for example, an acquiring unit (a user information acquiring unit) to be described later.

The information processing apparatus 200 determines whether or not the transferred electronic value is usable, for example, by determining whether or not the user of the information processing apparatus 200 is the authorized user.

For example, the information processing apparatus 200 identifies the user on the basis of biometric authentication of an arbitrary scheme such as face authentication, iris authentication, fingerprint authentication, or the like based on the captured image. Then, the information processing apparatus 200 determines whether or not the user of the information processing apparatus 200 is the authorized user by determining whether or not the identified user is the authorized user specified in the condition related to the authorized user permitted to use the transferred electronic value.

Here, the device related to the biometric authentication such as an imaging device related to capturing of the captured image may be a device installed in the information processing apparatus 200 or a device outside the information processing apparatus 200.

The information processing apparatus 200 determines that the transferred electronic value is not usable in a case in which the user of the information processing apparatus 200 is not determined to be an authorized user. Then, the information processing apparatus 200 restricts the function related to the use of the electronic value as described above.

Further, in a case in which it is determined that the user of the information processing apparatus 200 is the authorized user, the information processing apparatus 200 determines that the transferred electronic value is usable. Then, the information processing apparatus 200 does not restrict the function related to the use of the electronic value.

(4) Fourth Example of Function Control Process: Example in which use Condition Indicated by Condition Information is Condition Related to State of Predetermined Application

As the use condition indicated by the condition information, a condition related to a state of a predetermined application may be used.

As the condition related to the state of the predetermined application, for example, a condition in which a state of a predetermined application permitted to use the electronic value is directly specified, for example, “it is valid in a case in which a set application is activated,” “it is valid in a case in which a specific setting is made in a set application,” or the like may be used. Further, the condition related to the state of the predetermined application may be, for example, a condition in which the state of the application not permitted to use the electronic value is specified, for example, “it is valid in a case in which the set application is not activated” or the like.

In a case in which the function control process according to the fourth example is performed, the information processing apparatus 200 determines whether or not the transferred electronic value is usable on the basis of the state of the predetermined application and the condition related to the state of the predetermined application. The state of the predetermined application is acquired by specifying the state of the application through, for example, an acquiring unit (an application state acquiring unit) to be described later.

The information processing apparatus 200 determines whether or not whether or not the transferred electronic value is usable by determining whether or not a state of a predetermined application corresponding to the condition related to the state of the predetermined application satisfies the condition related to the state of the predetermined application.

As an example, for example, the information processing apparatus 200 specifies the state of the application in the information processing apparatus 200. Then, the information processing apparatus 200 determines whether or not the state of the predetermined application satisfies the condition related to the state of the predetermined application by determining whether or not the specified state of the application satisfies the condition related to the state of the predetermined application.

The information processing apparatus 200 determines that the transferred electronic value is not usable if it is determined that the state of the predetermined application does not satisfy the condition related to the state of the predetermined application. Then, the information processing apparatus 200 restricts the function related to the use of the electronic value as described above.

Further, the information processing apparatus 200 determines that the transferred electronic value is usable in a case in which it is determined that the state of the predetermined application satisfies the condition related to the state of the predetermined application. Then, the information processing apparatus 200 does not restrict the function related to the use of the electronic value.

### (5) Fifth Example of Function Control Process

The information processing apparatus 200 perform a process in which two or more of the function control processes according to the first example illustrated in (1) to the function control process according to the first example illustrated in (4) are combined. In other words, two or more of the use condition according to the first example illustrated in (1) to the use condition according to the fourth example illustrated in (4) may be included in the condition information according to the present embodiment.

In a case in which two or more use conditions are included in the condition information, for example, the information processing apparatus 200 determines that the transferred electronic value is not usable in a case in which it is determined that any one of the two or more use conditions is not satisfied. Then, the information processing apparatus 200 then restricts the function related to the use of the electronic value as described above.

Further, the information processing apparatus 200 determines that the transferred electronic value is usable, for example, in a case in which it is determined that all of the two or more use conditions are satisfied. Then, the information processing apparatus 200 does not restrict the function related to the use of the electronic value.

The information processing apparatus 200 performs any one of the processes (1) to (5) for each transferred electronic value as the function control process.

Further, the condition information according to the present embodiment and the function control process according to the present embodiment are not limited to the above examples.

For example, a use condition related to a credit function (to be described later) may be included in the condition information according to the present embodiment. The use condition related to the credit function includes, for example, information related to an amount of transferable electronic value. In a case in which the use condition related to the credit function is included in the condition information according to the present embodiment, the information processing apparatus 200 can further perform the function control process based on the use condition related to the credit function in addition to any of the process illustrated in (1) to the process (5). An example of a process related to payment using the credit function will be described later.

Further, the use condition related to the credit function is not limited to being included in the condition information but may be specified in information different from the condition information. The following description will proceed mainly with an example in which the use condition related to the credit function is specified in credit condition information (an example of information different from the condition information (to be described later).

Here, in the information processing system 1000, the transfer of the electronic value to the information processing apparatus 200 may be performed twice or more. Further, in a case in which the transfer of the electronic value to the information processing apparatus 200 is performed twice or more, in in the information processing apparatus 200, the function related to the use of the electronic value may be restricted by the function control process on one or more of electronic values among the transferred electronic values.

In a case in which the function related to the use of the electronic value is restricted by the function control process on one or more electronic values as described above, in the information processing apparatus 200, the use of the electronic value is restricted until the restriction of the function related to the use of all the electronic values is cancelled.

Further, as described above, if the function related to the use of the electronic value is restricted by the function control process on one or more electronic values, the information processing apparatus 200 may further perform a notification control process of giving a notification indicating that the use of the electronic value is restricted to the user.

For example, the information processing apparatus 200 gives a visual notification indicating that the use of the electronic value is restricted by causing either or both of a character string indicating that the use of the electronic value is restricted and an image indicating that the use of the electronic value is restricted to be displayed on a display screen of a display device. At this time, for example, the information processing apparatus 100 may cause information indicating “that the function related to the use of the electronic value is restricted since the use of some electronic values is restricted” and a “value of an electronic value whose use is not restricted (although it is actually in an unusable state due to the restriction of the function related to the use of the electronic value) to be displayed on the display screen.

Here, the display device may be a device installed in the information processing apparatus 200 or a device outside the information processing apparatus 200.

Further, the information processing apparatus 200 can give an audible notification indicating that the use of the electronic value is restricted by causing a sound indicating that the use of the electronic value is restricted to be output from, for example, an audio output device such as a speaker. At this time, for example, the information processing apparatus 100 may cause a “sound indicating that the function related to the use of the electronic value is restricted since the use of some electronic value is restricted” and a “sound indicating a value of an electronic value whose use is not restricted (although it is actually in an unusable state due to the restriction of the function related to the use of the electronic value) to be output from the audio output device.

Here, the audio output device may be a device installed in the information processing apparatus 200 or may be a device outside the information processing apparatus 200.

For example, as described above, the information processing apparatus 200 gives to the user, the notification indicating that the use of the electronic value is restricted by either or both of the visual notification method and the audible notification method, and thus the user can recognize that the use of the electronic value is restricted. Accordingly, since the information processing apparatus 200 gives to the user, the notification indicating that the use of the electronic value is restricted by either or both of the visual notification method and the audible notification method, it is possible to improve the convenience of the user.

The information processing apparatus 200 performs the function control process described above and the control of the function related to the use of the electronic value as the process related to the information processing method according to the present embodiment.

Therefore, since the function control process described above is performed as the process related to the information processing method according to the present embodiment, the information processing apparatus 200 can control the use of the electronic value transferred from the transfer source without relying on whether or not the payment apparatus has the function of determining whether or not the electronic value is usable.

Further, the function control process related to the information processing method according to the present embodiment is not restricted to the process described above.

For example, the information processing apparatus 200 may further control the credit function on the basis of the credit condition information.

Here, the credit function according to the present embodiment is a function related to addition of the electronic value using the credit information. Examples of the credit information according to the present embodiment include “data related to a credit card such as a credit card number and an effective period,” “data indicating a value of an electronic value to be added with credit as security.” The value of the electronic value to be added with the credit as the security according to the present embodiment is, for example, a value of an electronic value associated with the transfer source apparatus (a so-called balance in the transfer source apparatus). In a case in which the credit information indicates “data indicating the value of the electronic value to be added with credit as security,” a credit function in which an electronic value associated with transfer source apparatus is set as a credit range is implemented. An example of payment using the credit function will be described later.

Further, the credit condition information according to the present embodiment is data indicating the use condition related to the credit function. As the use condition related to the credit function indicated by the credit condition information, for example, a condition in which “the credit condition information indicates that the credit function is usable” may be used. Further, for example, information related to an amount of transferable electronic value may be included in the use condition related to the credit function as described above. Further, similarly to the use condition related to the transferred electronic value, one or more of a condition related to the effective period of the credit function, a condition related to the valid place of the credit function, a condition related to the authorized user permitted to use the credit function, and a condition related to the state of the predetermined application may be further included in the use condition related to the credit function indicated by the credit condition information.

For example, the credit condition information is generated by a manipulation of the user on the transfer source apparatus in a case in which the transfer of the electronic value is performed.

The information processing apparatus 200 enables the credit function, for example, in a case in which the credit condition information indicates that the credit function is usable. Further, in a case in which the use condition related to the credit function is included in the credit condition information, for example, the information processing apparatus 200 enables the credit function “when the credit condition information indicates that the credit function is usable, and the use condition related to the credit function indicated by the credit condition information is satisfied.”

For example, the information processing apparatus 200 determines whether or not the use condition related to the credit function is satisfied by determining whether or not an electronic value exceeding the balance of the transferred electronic value is usable on the basis of information related to the balance of the electronic value associated with the transfer source and a deficit of the electronic value. The information processing apparatus 200 determines that the use condition related to the credit function is satisfied, for example, in a case in which it is determined that the electronic value exceeding the balance of the transferred electronic value is usable.

Here, the information related to the balance is acquired through the second management apparatus 400. The information related to the balance is acquired, for example, by communication with the second management apparatus 400 being controlled by an acquiring unit (a balance information acquiring unit) to be described later.

Further, the deficit of the electronic value is obtained, for example, by an operation of subtracting a payment amount from the balance of the electronic value in an acquiring unit (a deficit acquiring unit) to be described later.

In a case in which the credit function is enabled, it is possible to add an electronic value using the credit information even in a case in which the value of the electronic value is deficient at the time of payment (a so-called balance is not enough), and thus it is possible to continue the payment.

Further, the information processing apparatus 200 disables the credit function, for example, in a case in which the credit condition information does not indicate that the credit function is usable. Further, in a case in which the use condition related to the credit function is included in the credit condition information, the information processing apparatus 200 disables the credit function when the use condition related to the credit function indicated by the credit condition information is not satisfied although the credit condition information indicates that the credit function is usable.

In a case in which the credit function is disabled, for example, the addition of the electronic value using the credit information is restricted.

The information processing apparatus 200 can further control the credit function described above in the function control process related to the information processing method according to the present embodiment.

By further controlling the credit function as described above, for example, the following effects are obtained.
It is possible to deal with a case in which it is desired to add an electronic value in response to a request from a kind who is out carrying with the information processing apparatus 200.
It is possible to prevent the unauthorized use, for example, when the information processing apparatus 200 is lost in a case in which the use condition related to the credit function is included in the credit condition information.

Further, the process of dealing with a case in which the value of the electronic value is insufficient at the time of payment is not limited to the process related to the control of the credit function.

For example, in a case in which information related to post-pay type electronic money (deferred type electronic money) is acquired by a manipulation of the user on the transfer source apparatus performed, for example, in a case in which the transfer of the electronic value is performed, the information processing apparatus 200 can perform payment using information related to the post-pay type electronic money.

### [4] Specific Example of Process Related to Information Processing Method According to Present Embodiment

Next, a specific example of a process related to the information processing method according to the present embodiment will be described using the information processing system 1000 illustrated in FIG. 1 as an example. A case in which the information processing apparatus 100 and the information processing apparatus 200 communicate with each other by NFC will be described as an example.

[4-1] Process in Case in which use of Electronic Value is Started

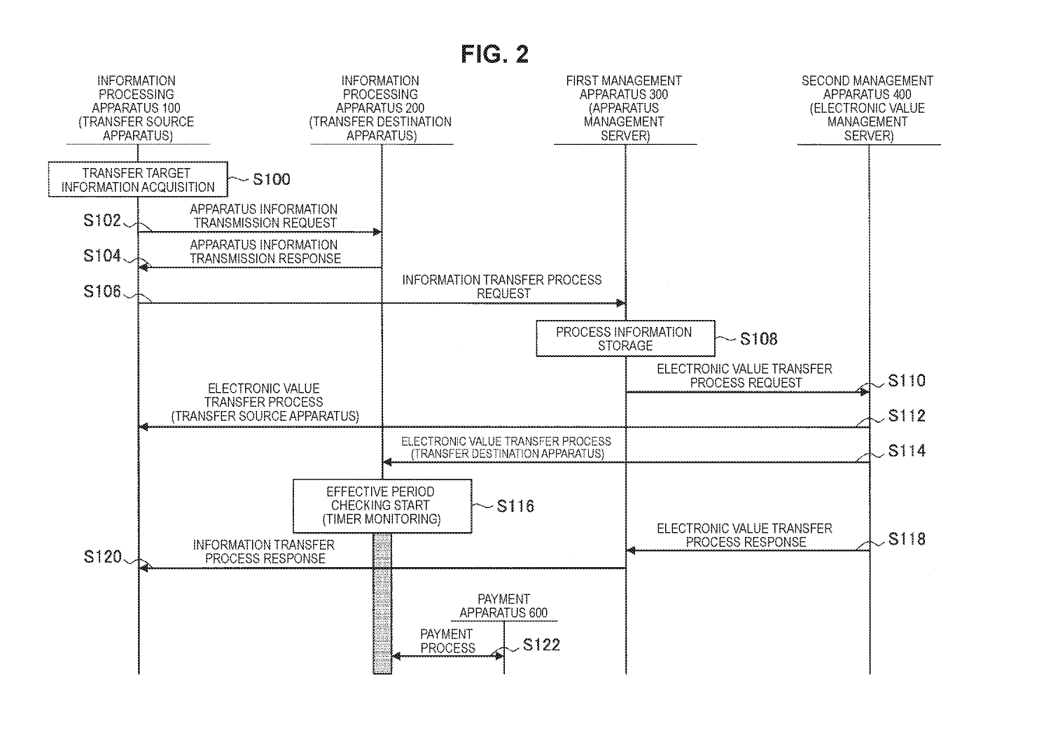

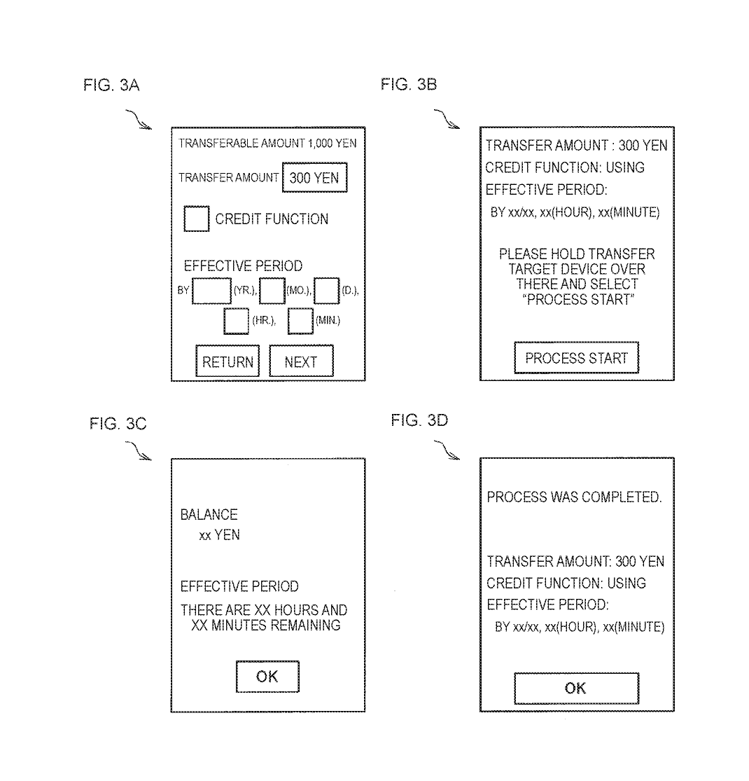

FIG. 2 and FIG. 3 are explanatory diagrams for describing an example of a process related to the information processing method according to the present embodiment.

FIG. 2 illustrates an example of a process performed when the use of the electronic value is started in the information processing system 1000. FIG. 2 illustrates a payment apparatus 600 installed in a payment place such as a store together. Further, FIG. 3 illustrates an example of a screen displayed on the display screen of the display device installed in the transfer source apparatus or the display screen of the display device installed in the transfer destination apparatus in a case in which a service related to the transfer of the electronic value is performed. Hereinafter, an example of a process performed when the use of the electronic value is started in the information processing system 1000 will be described with reference to FIGS. 2 and 3 appropriately.

The information processing apparatus 100 which is a transfer source apparatus acquires information related to a transfer target (S100). Here, as the information related to the transfer target, for example, the condition information related to the use condition of the electronic value can be used. Further, the information related to the transfer target may include information related to control of the credit function such as the credit condition information.

The information related to the transfer target is acquired, for example, by performing a manipulation on the screen as illustrated in A of FIG. 3 by the user of the information processing apparatus 100. In the example illustrated in A of FIG. 3, the value of the electronic value transferred from the transfer source apparatus (a “transfer amount” illustrated in A in FIG. 3), the usability of the credit function (a “credit function” illustrated in A of FIG. 3), and the effective period of the electronic value (an “effective period” illustrated in A of FIG. 3) are set in accordance with the manipulation of the user of the information processing apparatus 100.

In the screen illustrated in A in FIG. 3, if the user of the information processing apparatus 100 selects a “next” button, for example, a screen illustrated in B of FIG. 3 is displayed.

For example, if both the information processing apparatus 100 and the information processing apparatus 200 which is the transfer destination apparatus fall within the NFC communication coverage, and the user of the information processing apparatus 100 selects a “process start” button in the screen illustrated in B of FIG. 3, the information processing apparatus 100 transmits an apparatus information transmission request including a transmission command for an apparatus information (S102), and the information processing apparatus 200 transmits the apparatus information as a response to the apparatus information transmission request (S104). Here, the apparatus information according to the present embodiment is data which is a basis for generating the authentication information used for authentication. As the apparatus information according to the present embodiment, for example, an ID uniquely indicating an apparatus may be used.

The information processing apparatus 100 communicates with the first management apparatus 300 and transmits an information transfer process request to the first management apparatus 300 (S106). In a case in which the electronic value is transferred from the information processing apparatus 100 to the information processing apparatus 200, the information transfer process request includes, for example, a command for causing the information transfer process to be performed, information related to the transfer target, the apparatus information of the information processing apparatus 100, the apparatus information of the information processing apparatus 200, and the authentication information.

The first management apparatus 300 that has acquired information transfer process request transmitted in step S106 records various kinds of information included in the information transfer process request in the recording medium (S108) and manages each of the information processing apparatus 100 and the information processing apparatus 200. The first management apparatus 300 manages the information processing apparatus 100 and the information processing apparatus 200 by recording various kinds of information in the recording medium as a history. For example, the first management apparatus 300 manages the information processing apparatus 100 and the information processing apparatus 200 using a database or the like.

The first management apparatus 300 transmits an electronic value transfer process request to the second management apparatus 400 (S110). In a case in which the electronic value is transferred from the information processing apparatus 100 to the information processing apparatus 200, the electronic value transfer process request includes, for example, a command for causing the electronic value to be transferred from the information processing apparatus 100 to the information processing apparatus 200, information related to the transfer target, the apparatus information of the information processing apparatus 100, the apparatus information of the information processing apparatus 200, and the authentication information.

The second management apparatus 400 that has acquired electronic value transfer process request transmitted in step S110 performs an electronic value transfer process of causing the value of the electronic value of the transfer target to be subtracted on the information processing apparatus 100 which is the transfer source apparatus (S112). The second management apparatus 400 performs the electronic value transfer process on the information processing apparatus 100, for example, by transmitting the command for causing the value of the electronic value stored in the recording medium to be subtracted and data indicating the value to be subtracted to the information processing apparatus 100.

The second management apparatus 400 determines that the electronic value transfer process on the information processing apparatus 100 is normally completed in a case in which a response indicating that the subtraction of the electronic value is completed is acquired from the information processing apparatus 100. For example, in a case in which the response indicating that the subtraction of the electronic value is completed is not acquired from the information processing apparatus 100 although a set time elapses after the electronic value transfer process on the information processing apparatus 100 is started, the second management apparatus 400 determines that an error occurs, and ends the electronic value transfer process on the information processing apparatus 100.

In a case in which it is determined that the electronic value transfer process on the information processing apparatus 100 is normally completed, the second management apparatus 400 performs an electronic value transfer process of adding the value of the electronic value of the transfer target on the information processing apparatus 200 which is the transfer destination apparatus (S114). For example, the second management apparatus 400 performs the electronic value transfer process on the information processing apparatus 200 by transmitting a command for causing the value of the electronic value stored in the recording medium to be added and data indicating the value to be added to the information processing apparatus 200.

The second management apparatus 400 determines that the electronic value transfer process on the information processing apparatus 200 is normally completed in a case in which the response indicating that the addition of the electronic value is completed is acquired from the information processing apparatus 200. For example, in a case in which the response indicating that the addition of the electronic value is completed is not acquired from the information processing apparatus 200 although a set time elapses after the electronic value transfer process on the information processing apparatus 200 is started, the second management apparatus 400 determines that an error occurs, and ends the electronic value transfer process on the information processing apparatus 200. Further, if it is determined that an error occurs in the electronic value transfer process on the information processing apparatus 200, the second management apparatus 400 performs a process of returning the electronic value subtracted by the electronic value transfer process on the information processing apparatus 100 in step S112 to a state before the electronic value transfer process on information processing apparatus 100.

Further, in a case in which the electronic value transfer process request includes the condition information related to the use condition of the electronic value, the second management apparatus 400 transmits the condition information to the information processing apparatus 200. Further, in a case in which the electronic value transfer process request includes the information related to the control of the credit function such as the credit condition information, the second management apparatus 400 transmits the information related to the control of the credit function to the information processing apparatus 200.

As described above, the second management apparatus 400 transmits information according to the electronic value transfer process request to the information processing apparatus 200 functioning as the transfer destination apparatus on the basis of the electronic value transfer process request transmitted from the first management apparatus 300, and thus the information processing apparatus 200 acquires either or both of the condition information and the credit condition information. Further, as described above, the information processing apparatus 200 controls the function related to the use of the electronic value on the basis of the acquired condition information and controls the credit function on the basis of the acquired credit condition information. In other words, in the information processing system 1000, the condition information, the credit condition information, and the like are set in the transfer destination apparatus by the first management apparatus 300.

A case in which the second management apparatus 400 transmits the condition information indicating the condition related to the effective period of the transferred electronic value to the information processing apparatus 200 will be described below as an example.

As the process of step S114 is performed, the information processing apparatus 200 that has acquired condition information indicating the condition related to the effective period of the transferred electronic value determines whether or not the effective period is satisfied using, for example, a timer function of the information processing apparatus 200 (S116). For example, the information processing apparatus 200 determines whether or not the effective period is satisfied periodically or irregularly. Further, at this time, the information processing apparatus 200 may cause a notification screen illustrated in C of FIG. 3 to be displayed on the display screen.

If the process of step S112 and the process of step S114 are completed, the second management apparatus 400 transmits a response indicating that the process according to the electronic value transfer process request is completed to the first management apparatus 300 (S118).

The first management apparatus 300 that has acquired response transmitted in step S118 transmits a response indicating that the process according to the information transfer process request is completed to the information processing apparatus 100 (S120). Further, the information processing apparatus 100 that has acquired response transmitted in step S120 causes the completion screen illustrated in D of FIG. 3 to be displayed on the display screen.

If it is determined that the effective period is satisfied after the start of the process of step S116, the function related to the use of the electronic value is not restricted in the information processing apparatus 200. Therefore, in a case in which the payment using the electronic value is performed when it is determined that the effective period is satisfied after the start of the process of step S116, the payment process using the electronic value is performed between the payment apparatus 600 and the information processing apparatus 200 (S122).

When the use of the electronic value is started, the process illustrated in FIG. 2, for example, is performed in the information processing system 1000. Further, it will be appreciated that the example of the process in the information processing system 1000 when the use of the electronic value is started is not limited to the example illustrated in FIG. 2.

### [4-2] Process After Transfer of Electronic Value is Completed

### [4-2-1] First Example of Process After Transfer of Electronic Value is Completed

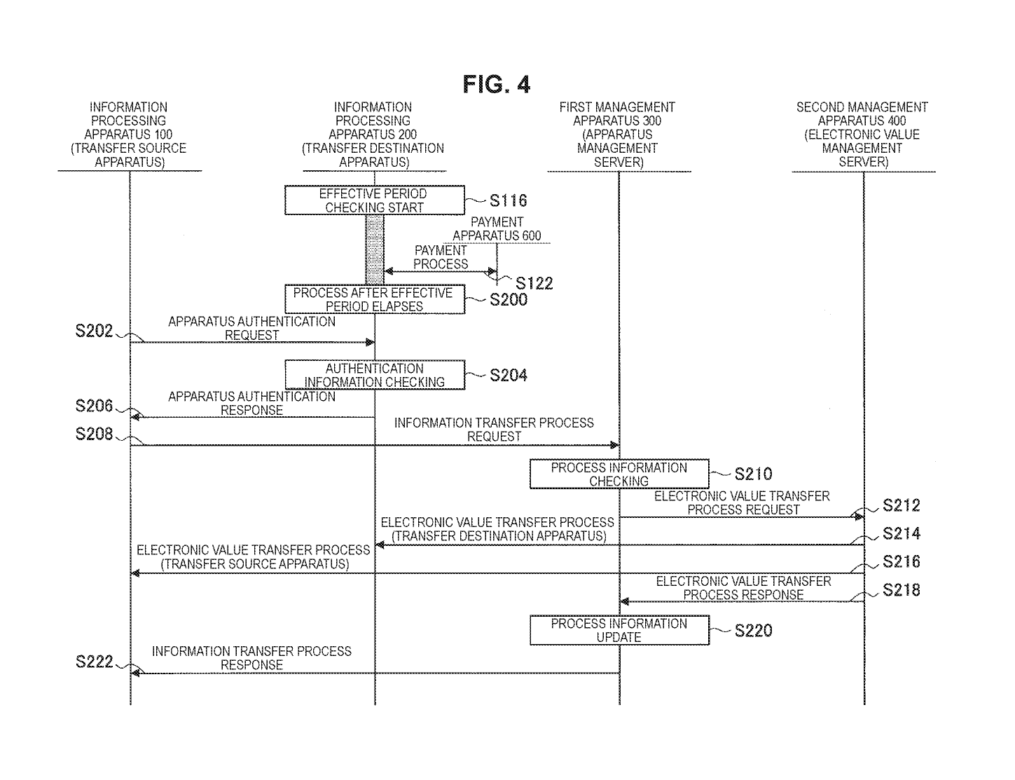

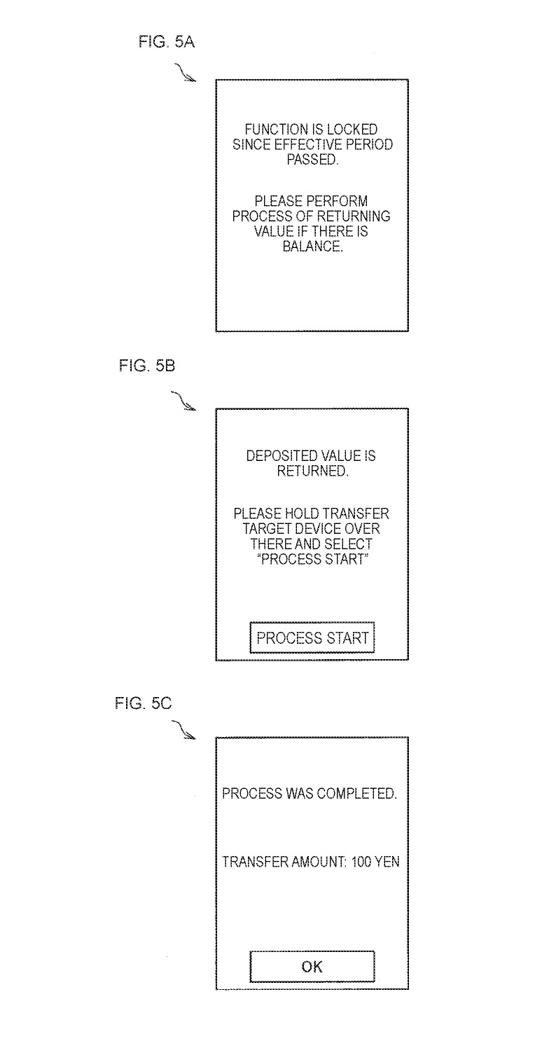

FIGS. 4 and 5 are explanatory diagrams for describing an example of a process related to the information processing method according to the present embodiment.

FIG. 4 illustrates a first example of the process after the transfer of the electronic value is completed in the information processing system 1000, and illustrates an example of the process after the process of FIG. 2 is performed. In FIG. 4, step S116 and step S122 of FIG. 2 are illustrated together for the sake of convenience. Further, FIG. 5 illustrates an example of a screen displayed on the display screen of the display device installed in the transfer source apparatus or the display screen of the display device installed in the transfer destination apparatus after the transfer of the electronic value is completed. A first example of the processing after the electronic value transfer is completed in the information processing system 1000 will be described below with reference to FIGS. 4 and 5 appropriately.

In a case in which it is determined that the effective period is not satisfied in the process of step S116, that is, in a case in which the effective period elapses, for example, the information processing apparatus 200 restricts a communication function used for the use of the electronic value (an example of the function related to the use of the electronic value) (S200). In a case in which the communication function used for the use of the electronic value is restricted, the information processing apparatus 200 does not make a response to a command transmitted from an apparatus that does not have the authentication information or transmits an error in response to the command.

Further, in a case in which the effective period elapses, the information processing apparatus 200 may cause a notification screen illustrated in A of FIG. 5 to be displayed on the display screen.

If both the information processing apparatus 100 and the information processing apparatus 200 which is the transfer destination apparatus fall within the communication coverage of NFC, the information processing apparatus 100 transmits an apparatus authentication request including an authentication command and the authentication information corresponding to the information processing apparatus 200 (S202).

The information processing apparatus 200 that has received the apparatus authentication request transmitted in step S202 determines whether or not the information processing apparatus 100 corresponds to a predetermined apparatus on the basis of the acquired authentication information (S204). In a case in which the acquired authentication information is the authentication information corresponding to the information processing apparatus 200, the information processing apparatus 200 determines that the information processing apparatus 100 corresponds to the predetermined apparatus.

If it is determined in step S204 that the information processing apparatus 100 corresponds to the predetermined apparatus, the information processing apparatus 200 cancels the restriction of the communication function used for the use of the electronic value (an example of the function related to the use of the electronic value).

Further, the information processing apparatus 200 transmits a response corresponding to the apparatus authentication request (S206). The response corresponding to the apparatus authentication request includes, for example, information indicating the value of the electronic value (so-called balance) which can be returned to the transfer source apparatus among the electronic value whose effective period has elapsed.

If the response corresponding to the apparatus authentication request transmitted in step S206 is acquired, for example, the screen illustrated in B of FIG. 5 is displayed. Further, for example, if the user of the information processing apparatus 100 selects the “process start” button in the screen illustrated in B of FIG. 5, the information processing apparatus 100 transmits an information transfer request for returning the electronic value transferred to the information processing apparatus 200 to the transfer source apparatus to the first management apparatus 300 (S208). Further, the information processing apparatus 100 may transmit the information transfer request to the first management apparatus 300 in response to the acquisition of the response corresponding to the apparatus authentication request.

The information transfer request for returning the transferred electronic value includes, for example, a process command and relevant information for returning the electronic value to the transfer source apparatus. Examples of the relevant information include information indicating a time at the electronic value is transferred, information indicating the value of the electronic value that can be returned, the condition information indicating the use condition such as the effective period, the apparatus information of the information processing apparatus 200, and the authentication information corresponding to the information processing apparatus 200.

The first management apparatus 300 that has acquired information transfer request transmitted in step S208 compares the relevant information included in the information transfer request with information recorded in the recording medium in step S108 of FIG. 2, and checks the validity of the relevant information (S210).

The first management apparatus 300 transmits the electronic value transfer process request for returning the electronic value to the transfer source apparatus to the second management apparatus 400 (S212). In a case in which the electronic value is returned from the information processing apparatus 200 to the information processing apparatus 200, the electronic value transfer process request for returning the electronic value to the transfer source apparatus includes, for example, a process command, the apparatus information of the information processing apparatus 100, the apparatus information of the information processing apparatus 200, and the information indicating the value of the transferred electronic value.

The second management apparatus 400 that has acquired electronic value transfer process request transmitted in step S212 performs the electronic value transfer process of causing the value of the electronic value to be subtracted so that the value of the electronic value whose effective period has elapsed becomes zero on the information processing apparatus 200 which is the transfer destination apparatus (S214). The second management apparatus 400 performs the electronic value transfer process on the information processing apparatus 200, for example, by transmitting the command for causing the value of the electronic value stored in the recording medium to be subtracted and data indicating the value to be subtracted to the information processing apparatus 200.

The second management apparatus 400 determines that the electronic value transfer process on the information processing apparatus 200 is normally completed in a case in which the response indicating that the subtraction of the electronic value is completed is acquired from the information processing apparatus 200. For example, in a case in which the response indicating that the subtraction of the electronic value is completed is not acquired from the information processing apparatus 200 although a set time elapses after the electronic value transfer process on the information processing apparatus 200 is started, the second management apparatus 400 determines that an error occurs, and ends the electronic value transfer process on the information processing apparatus 200. In addition, for example, in a case in which the response indicating that the subtraction of the electronic value is completed is not acquired from the information processing apparatus 200 although a set time elapses after the electronic value transfer process on the information processing apparatus 200 is started, the second management apparatus 400 may perform the electronic value transfer process again on the information processing apparatus 200.

In a case in which it is determined that the electronic value transfer process on the information processing apparatus 200 is normally completed, the second management apparatus 400 performs the electronic value transfer process for causing the “value of the electronic value which can be returned among the transferred electronic value (a so-called balance) on the information processing apparatus 100, which is the transfer source apparatus (S216). The second management apparatus 400 performs the electronic value transfer process on the information processing apparatus 100, for example, by transmitting the command for causing the value of the electronic value stored in the recording medium to be added and data indicating the value to be added to the information processing apparatus 100.

The second management apparatus 400 determines that the electronic value transfer process on the information processing apparatus 100 is normally completed in a case in which a response indicating that the addition of the electronic value is completed is acquired from the information processing apparatus 100. For example, in a case in which the response indicating that the addition of the electronic value is completed is not acquired from the information processing apparatus 200 although a set time elapses after the electronic value transfer process on the information processing apparatus 100 is started, the second management apparatus 400 determines that an error occurs, and ends the electronic value transfer process on the information processing apparatus 100. In addition, for example, in a case in which the response indicating that the addition of the electronic value is completed is not acquired from the information processing apparatus 100 although a set time elapses after the electronic value transfer process on the information processing apparatus 100 is started, the second management apparatus 400 may perform the electronic value transfer process again on the information processing apparatus 100. Further, if it is determined that an error occurs in the electronic value transfer process on the information processing apparatus 100, the second management apparatus 400 performs a process of returning the electronic value subtracted by the electronic value transfer process on the information processing apparatus 200 in step S214 to a state before the electronic value transfer process on information processing apparatus 200.

In a case in which it is determined that the process of step S214 and the process of step S216 are normally completed, the second management apparatus 400 transmits a response indicating that the process corresponding to the electronic value transfer process request is completed to the first management apparatus 300 (S218).

The first management apparatus 300 that has acquired response transmitted in step S218 records, for example, the information related to the process, for example, the time at which the process is executed, the value of the transferred electronic value, and the like in the recording medium as a history (step S220).

In addition, the first management apparatus 300 transmits a response indicating that the process according to the information transfer process request is completed to the information processing apparatus 100 (S222). Further, the information processing apparatus 100 that has acquired response transmitted in step S222 causes the completion screen illustrated in C of FIG. 5 to be displayed on the display screen.

After the transfer of the electronic value is completed, for example, the process illustrated in FIG. 4 is performed in the information processing system 1000. Further, the example of the process in the information processing system 1000 after the transfer of the electronic value is completed is not limited to the example illustrated in FIG. 4.

[4-2-2] Second Example of Process after Transfer of Electronic Value is Completed

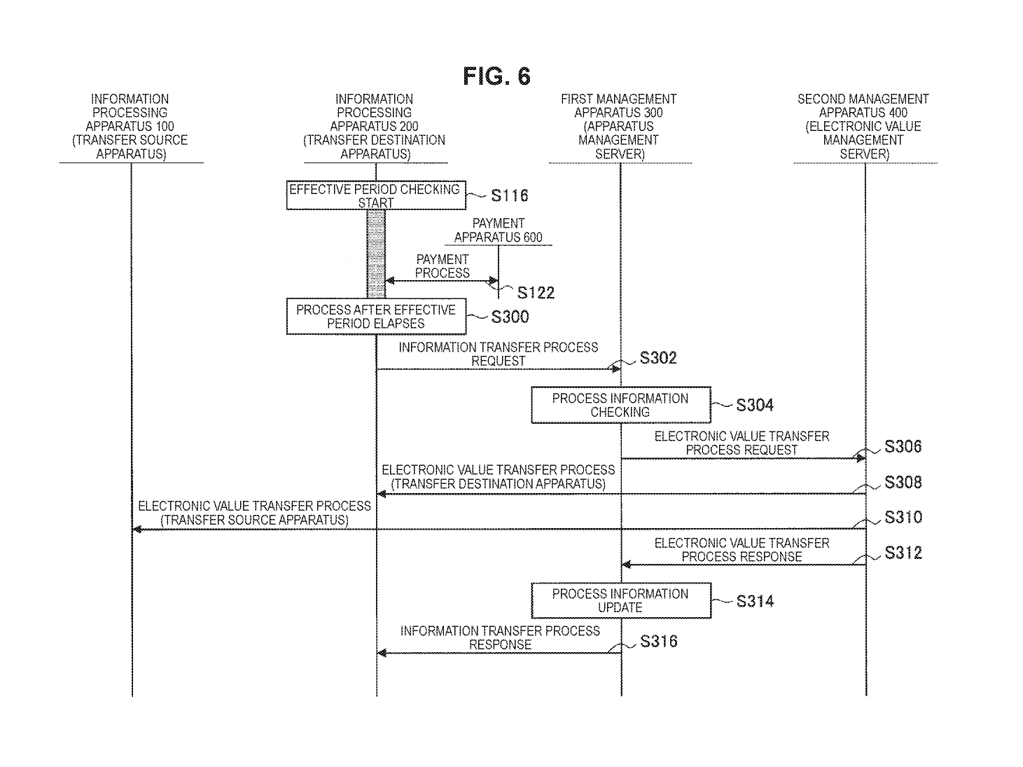

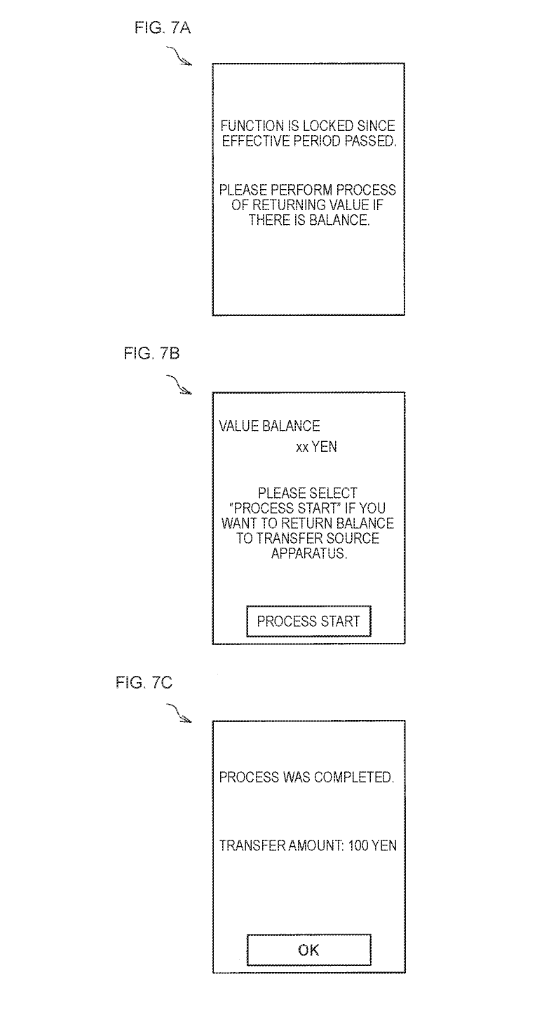

FIGS. 6 and 7 are explanatory diagrams for describing an example of a process related to the information processing method according to the present embodiment.

FIG. 6 illustrates a second example of the process after the transfer of the electronic value is completed in the information processing system 1000, and illustrates another example of the process after the process of FIG. 2 is performed. In FIG. 6, step S116 and step S122 of FIG. 2 are illustrated together for the sake of convenience. Further, FIG. 7 illustrates an example of a screen displayed on the display screen of the display device installed in the transfer source apparatus or the display screen of the display device installed in the transfer destination apparatus after the transfer of the electronic value is completed. A second example of the processing after the electronic value transfer is completed in the information processing system 1000 will be described below with reference to FIGS. 6 and 7 appropriately.

In a case in which it is determined that the effective period is not satisfied in the process of step S116, that is, in a case in which the effective period elapses, the information processing apparatus 200 restricts the communication function used for the use of the electronic value (an example of the function related to the use of the electronic value), similarly to, for example, step S200 of FIG. 4, (S300).

Further, in a case in which the effective period elapses, the information processing apparatus 200 causes, for example, a notification screen illustrated in A of FIG. 7 and a notification screen illustrated in B of FIG. 7 to be displayed on the display screen.

In a case in which the user of the information processing apparatus 200 selects the “process start” button in the screen illustrated in FIG. 7B, the information processing apparatus 200 transmits the information transfer request for returning the electronic value transferred to the information processing apparatus 200 to the transfer source apparatus to the first management apparatus 300 (S302). Further, the information processing apparatus 100 may transmit the information transfer request to the first management apparatus 300 in accordance with the execution of the process of step S300.

The information transfer request for returning the transferred electronic value includes, for example, a process command and relevant information for returning the electronic value to the transfer source apparatus. Examples of the relevant information include information indicating a time at the electronic value is transferred, information indicating the value of the electronic value that can be returned, the condition information indicating the use condition such as the effective period, the apparatus information of the information processing apparatus 100, and the authentication information corresponding to the information processing apparatus 200.

The first management apparatus 300 that has acquired information transfer request transmitted in step S302 compares the relevant information included in the information transfer request with information recorded in the recording medium in step S108 of FIG. 2 like Step S210 in FIG. 4, and checks the validity of the relevant information (S304).

The first management apparatus 300 transmits the electronic value transfer process request for returning the electronic value to the transfer source apparatus to the second management apparatus 400, similarly to step S212 of FIG. 4 (S306).

The second management apparatus 400 that has acquired electronic value transfer process request transmitted in step S306 performs the electronic value transfer process of causing the value of the electronic value to be subtracted so that the value of the electronic value whose effective period has elapsed becomes zero on the information processing apparatus 200 which is the transfer destination apparatus, similarly to step S214 of FIG. 4 (S308).

In a case in which it is determined that the electronic value transfer process on the information processing apparatus 200 is normally completed, the second management apparatus 400 performs the electronic value transfer process for causing the “value of the electronic value which can be returned among the transferred electronic value (a so-called balance) on the information processing apparatus 100, which is the transfer source apparatus, similarly to step S216 of FIG. 4 (S310).

In a case in which it is determined that the process of step S308 and the process of step S310 are normally completed, the second management apparatus 400 transmits a response indicating that the process corresponding to the electronic value transfer process request is completed to the first management apparatus 300 (S312) in a way similar to Step S218 in FIG. 4.

The first management apparatus 300 that has acquired response transmitted in step S312 records, for example, the information related to the process, for example, the time at which the process is executed, the value of the transferred electronic value, and the like in the recording medium as a history (step S314) in a way similar to Step S220 in FIG. 4.

In addition, the first management apparatus 300 transmits a response indicating that the process according to the information transfer process request is completed to the information processing apparatus 200 (S316). Further, the information processing apparatus 100 that has acquired response transmitted in step S316 causes the completion screen illustrated in C of FIG. 7 to be displayed on the display screen.

### [4-2-3] Third Example of Process After Transfer of Electronic Value is Completed

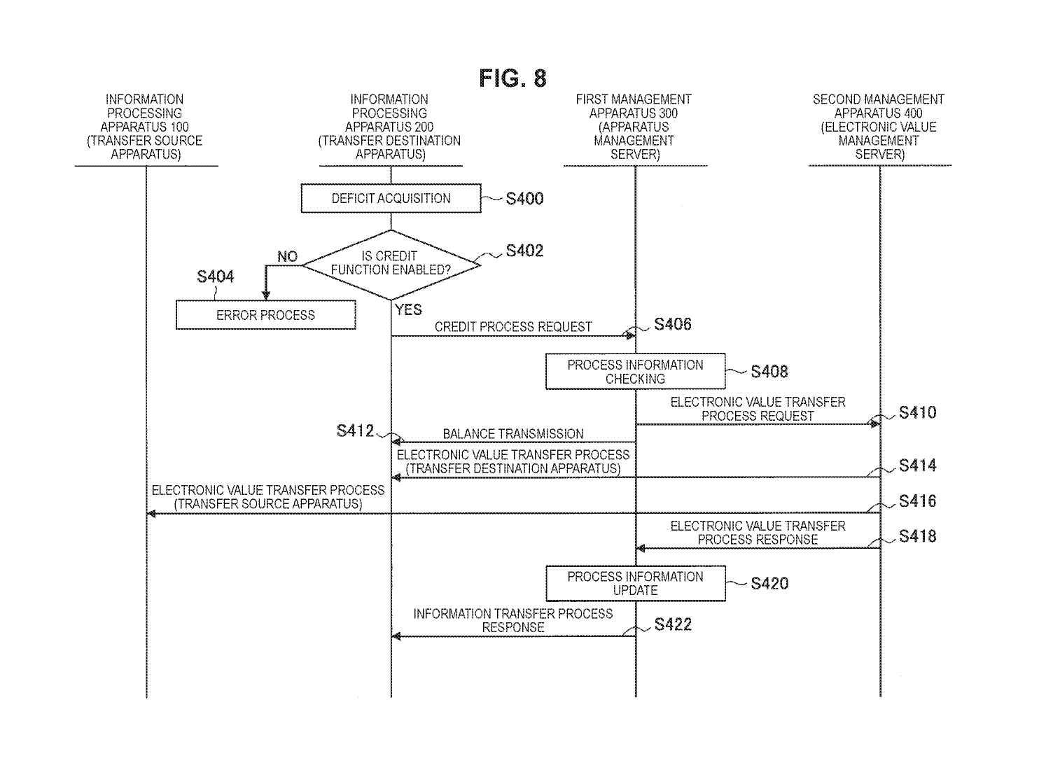

FIG. 8 is an explanatory diagram for describing an example of a process related to the information processing method according to the present embodiment.

FIG. 8 illustrates a third example of the process after the transfer of the electronic value is completed in the information processing system 1000, and illustrates another example of the process after the process of FIG. 2 is performed. FIG. 8 illustrates an example of the process related to payment using the credit function.

The information processing apparatus 200 acquires a deficit in the payment using the electronic value (S400). For example, the information processing apparatus 200 acquires the deficit by performing an operation of subtracting the payment amount from the balance of the electronic value.

The information processing apparatus 200 determines whether or not the credit function is enabled (S402). The information processing apparatus 200 determines that the credit function is enabled, for example, in a case in which it is determined that the use condition related to the credit function is satisfied.

If it is determined in step S402 that the credit function is not enabled, the information processing apparatus 200 performs the error process (S404). In the example illustrated in FIG. 8, the error process is performed in step S404, and the process related to the payment ends.

As the error process in step S404, for example, a process of notifying the user of the information processing apparatus 200 of an error indicating that payment is unable to be made or the like may be performed. The information processing apparatus 200 notifies of an error by an arbitrary method capable of giving an error to the user to the information processing apparatus 200 such as a visual notification method by causing a character or an image to be displayed on the display screen, an audible notification method by causing a sound indicating an error from an audio output device such as a speaker, or a combination thereof.

Further, the process of step S404 is not limited to the example described above. For example, the information processing apparatus 200 may cause the information indicating an error indicating that the payment is unable to be made to be transmitted to the transfer source apparatus such as the information processing apparatus 100 via the first management apparatus 300. As the information indicating the error is transmitted to the transfer source apparatus, for example, the user of the transfer source apparatus can understand that the information processing apparatus 200 is in a non-payable state. Further, by understanding that the information processing apparatus 200 is in the non-payable state, the user of the transfer source apparatus performs, for example, a manipulation related to the transfer of the electronic value illustrated in FIG. 2, so that the electronic value can be transferred to the information processing apparatus 200.

If it is determined in step S402 that the credit function is enabled, the information processing apparatus 200 transmits the credit process request for causing the process related to the transfer of the electronic value using the credit function to be performed to the first management apparatus 300 (S406). The credit process request includes, for example, the apparatus information of the information processing apparatus 200 and the information indicating the deficit, that is, the information indicating the value of the electronic value which is requested to be transferred. Here, the credit process request transmitted in step S406 corresponds to the electronic value transfer request based on the use condition related to the credit function.

The first management apparatus 300 that has obtained the credit process request transmitted in step S406 compares, for example, the apparatus information of the information processing apparatus 200 included in the credit process request with the information recorded in the recording medium in step S108 of FIG. 2, and checks the validity of the information included in the credit process request (S408).

The first management apparatus 300 transmits the electronic value transfer process request for causing the electronic value which is requested to be transferred indicated by the credit process request to the information processing apparatus 200 to the second management apparatus 400 (S410). Further, the first management apparatus 300 transmits, for example, the information related to the balance of the electronic value associated with the information processing apparatus 100 which is a transfer source apparatus to the information processing apparatus 200 (S412).

The second management apparatus 400 that has acquired electronic value transfer process request transmitted in step S410 performs the electronic value transfer process for causing the value of the electronic value which is requested to be transferred indicated by the credit process request to be added on the information processing apparatus 200 which is the transfer destination apparatus (S414).

In a case in which it is determined that the electronic value transfer process on the information processing apparatus 200 is normally completed, the second management apparatus 400 performs the electronic value transfer process for causing the value of the electronic value which is requested to be transferred indicated by the credit process request to be subtracted on the information processing apparatus 100 which is the transfer source apparatus (S416).

In a case in which it is determined that the process of step S414 and the process of step S416 are normally completed, the second management apparatus 400 transmits a response indicating that the process corresponding to the electronic value transfer process request is completed to the first management apparatus 300 (S418) in a way similar to Step S218 in FIG. 4.

The first management apparatus 300 that has acquired response transmitted in step S418 records, for example, the information related to the process, for example, the time at which the process is executed, the value of the transferred electronic value, and the like in the recording medium as a history (step S420) in a way similar to Step S220 in FIG. 4.

Further, the first management apparatus 300 transmits the response indicating that the process according to the information transfer process request is completed to the information processing apparatus 200 (S422).

After the transfer of the electronic value is completed, for example, the process as illustrated in FIG. 6 or FIG. 8 may be performed in the information processing system 1000. Further, it will be appreciated that the example of the process in the information processing system 1000 after the transfer of the electronic value is completed is not limited to the example illustrated in FIGS. 4, 6, and 8.

### [4-3] Process Related to Use State Update

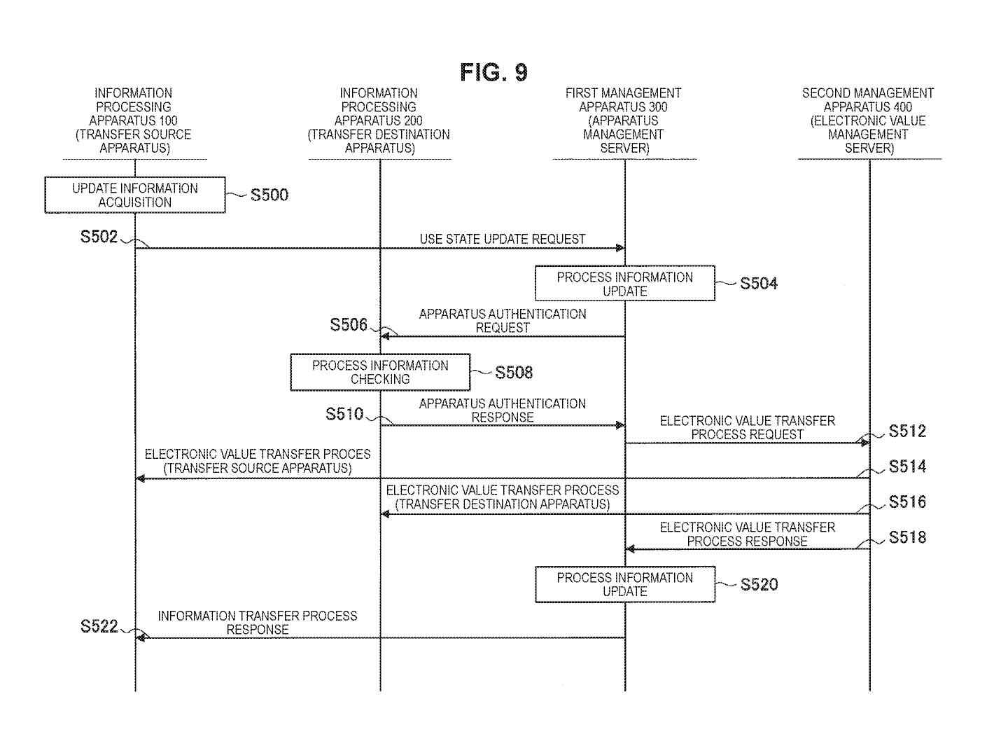

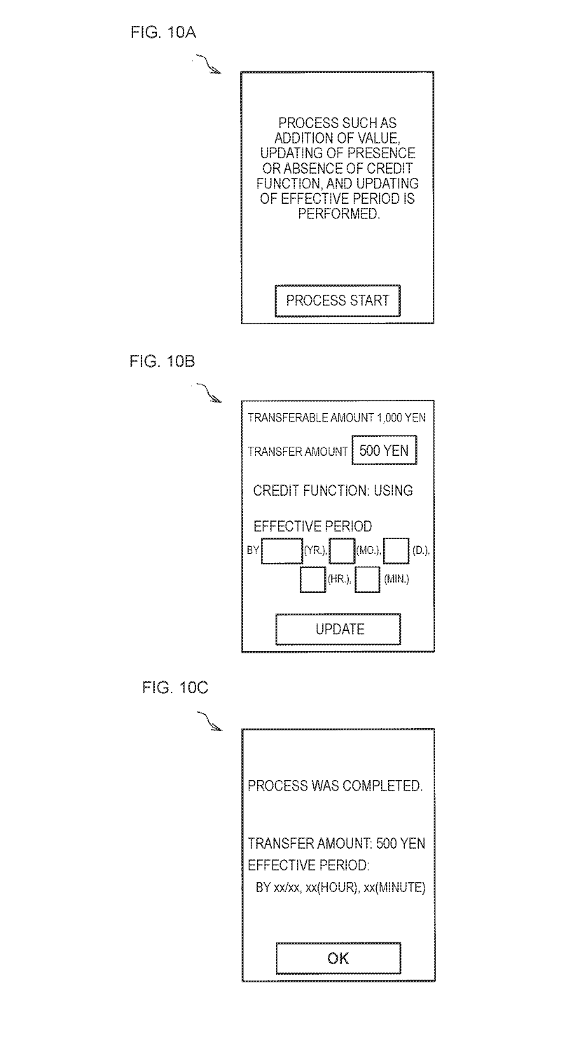

FIGS. 9 and 10 are explanatory diagrams for describing an example of a process related to the information processing method according to the present embodiment.

FIG. 9 illustrates an example of a process related to the use state update in the information processing system 1000. Further, FIG. 10 illustrates an example of a screen displayed on the display screen of the display device installed in the transfer source apparatus or the display screen of the display device installed the transfer destination apparatus at the time of use state update. An example of the process related to the use state update in the information processing system 1000 will be described below with reference to FIGS. 9 and 10 appropriately.

Here, examples of the use state update according to the present embodiment include addition of the electronic value, changing of the use condition such as updating of the effective period, and changing of an enable/disable setting of the credit function on the transfer destination apparatus to which the transfer has been performed after the transfer of the electronic value is performed. Further, the addition of the electronic value is an example of the transfer of the electronic value.

The information processing apparatus 100 which is the transfer source apparatus acquires update information (S500). Examples of the update information include information related to the control of credit functions such as the information indicating the value of the electronic value to be added, the condition information related to the use condition of the electronic value, and the credit condition information.

If the user of the information processing apparatus 100 selects “process start” in a screen as illustrated in A of FIG. 10, a screen illustrated in B of FIG. 10 is displayed. The update information is acquired, for example, by performing a manipulation on the screen as illustrated in B of FIG. 10 by the user of the information processing apparatus 100. In the example illustrated in B of FIG. 10, the value of the electronic value newly transferred from the transfer source apparatus (a “transfer amount” illustrated in A in FIG. 10), the usability of the credit function (a “credit function” illustrated in A of FIG. 10), and the effective period of the electronic value (an “effective period” illustrated in A of FIG. 10) are set in accordance with the manipulation of the user of the information processing apparatus 100.

For example, if the user of the information processing apparatus 100 selects an “update” button in the screen illustrated in B of FIG. 10, the information processing apparatus 100 communicates with the first management apparatus 300 and transmits a use state update request to the first management apparatus 300 (S502). In a case in which the use state of the information processing apparatus 200 is updated from the information processing apparatus 100, the use state update request includes, for example, a command for causing a process related to the use state update to be performed, update information, the apparatus information of the information processing apparatus 100, and the apparatus information of the information processing apparatus 200.

The first management apparatus 300 that has acquired use state update request transmitted in step S502 updates information managed in the first management apparatus 300 (for example, the information recorded in the recording medium in step S108 of FIG. 2) on the basis of various kinds of information included in the use state update request (S504).

The first management apparatus 300 transmits the apparatus authentication request including the authentication command and the authentication information corresponding to the information processing apparatus 200 to the information processing apparatus 200 (S506). Here, the authentication information corresponding to the information processing apparatus 200 included in the apparatus authentication request in step S506 may be the authentication information recorded in the recording medium in step S108 of FIG. 2.

Similarly to S204 of FIG. 4, the information processing apparatus 200 that has received the apparatus authentication request transmitted in step S506 determines whether or not the first management apparatus 300 corresponds to a predetermined apparatus on the basis of the acquired authentication information (S508). Further, if it is determined that the first management apparatus 300 corresponds to the predetermined apparatus, the information processing apparatus 200 transmits a response corresponding to the apparatus authentication request to the first management apparatus 300 (S510).

If the response corresponding to the apparatus authentication request transmitted in step S510 is acquired, the first management apparatus 300 transmits the electronic value transfer process request to the second management apparatus 400, similarly to step S110 of FIG. 2 (S512). In a case in which the electronic value is added from the information processing apparatus 100 to the information processing apparatus 200, the electronic value transfer process request includes, for example, the command for causing the electronic value to be transferred from the information processing apparatus 100 to the information processing apparatus 200, the information indicating the value of the electronic value to be added, the apparatus information of the information processing apparatus 100, the apparatus information of the information processing apparatus 200, and the authentication information. Further, in a case in which the use condition of the transferred electronic value is updated in the information processing apparatus 200, the electronic value transfer process request includes, for example, the condition information indicating a new use condition. Further, in a case in which the enable/disable setting of the credit function is updated in the information processing apparatus 200, the electronic value transfer process request includes, for example, the information related to the control of the credit function such as the credit condition information.

The second management apparatus 400 that has acquired electronic value transfer process request transmitted in step S512 performs the electronic value transfer process for causing the value of the electronic value of the transfer target to be subtracted on the information processing apparatus 100 which is the transfer source apparatus, similarly to step S112 of FIG. 2 (S514).

In a case in which it is determined that the electronic value transfer process on the information processing apparatus 100 is normally completed, the second management apparatus 400 performs the electronic value transfer process for causing the value of the electronic value of the transfer target to be added on the information processing apparatus 200 which is the transfer destination apparatus, similarly to step S114 in FIG. 2 (S516).

Further, in a case in which the electronic value transfer process request includes the condition information, the second management apparatus 400 transmits the condition information to the information processing apparatus 200. Further, in a case in which the electronic value transfer process request includes the information related to the control of the credit function such as the credit condition information, the second management apparatus 400 transmits the information related to the control of the credit function to the information processing apparatus 200.

As described above, the second management apparatus 400 transmits information according to the electronic value transfer process request to the information processing apparatus 200 functioning as the transfer destination apparatus on the basis of the electronic value transfer process request transmitted from the first management apparatus 300, and thus the information processing apparatus 200 acquires either or both of the condition information and the credit condition information, and the use state is updated. As described above, the information processing apparatus 200 controls the function related to the use of the electronic value on the basis of the acquired condition information and controls the credit function on the basis of the acquired credit condition information. In other words, in the information processing system 1000, the condition information, the credit condition information, and the like are set in the transfer destination apparatus by the first management apparatus 300.

If the process of step S514 and the process of step S516 are completed, the second management apparatus 400 transmits a response indicating that the process according to the electronic value transfer process request is completed to the first management apparatus 300 (S518).

The first management apparatus 300 that has acquired response transmitted in step S518 records, for example, the information related to the process, for example, the time at which the process is executed, the value of the transferred electronic value, and the like in the recording medium as a history (step S520).

In addition, the first management apparatus 300 transmits a response indicating that the process according to the use state update request is completed to the information processing apparatus 100 (S522). Further, the information processing apparatus 100 that has acquired response transmitted in step S522 causes the completion screen illustrated in C of FIG. 10 to be displayed on the display screen.

At the time of the use state update, for example, the process illustrated in FIG. 9 is performed in the information processing system 1000. Further, it will be appreciated that the example of the processing in the information processing system 1000 at the time of use state update is not limited to the example illustrated in FIG. 9.

[5] Example of Effects Obtained by using Information Processing Method According to Present Embodiment

As the information processing apparatus according to the present embodiment corresponding to the transfer destination apparatus performs the process related to the information processing method according to the present embodiment, for example, the following effects are obtained. Further, it will be appreciated that the effects obtained by using the information processing method according to the present embodiment are not restricted to the following effects.
The transfer destination apparatus checks the use condition on the basis of the condition information indicating the use condition such as the effective period acquired together with the transfer of the electronic value, and thus it is possible to set the use condition in the transferred electronic value without relying on the payment apparatus or the server side related to the payment. Further, the user of the transfer destination apparatus can easily check the current state, for example, by looking at the use condition such as the balance and the effective period displayed on the display screen of the display device installed in the transfer destination apparatus.
Since it is possible to perform the addition of the electronic value, the updating of the use condition such as the effective period, the updating of the usability of the credit function, and the like by manipulating the transfer source apparatus, for example, even in a case in which in which it is desired to add an electronic value in response to a request from a kid who is out carrying with the transfer destination apparatus, it is possible to deal with it immediately. Further, even in a case in which the transfer destination apparatus is lost, since the use condition such as the effective period is updated, it is possible to prevent the unauthorized use of the transferred electronic value.
In addition to the transfer of the electronic value, it is possible to cause the transfer destination apparatus to acquire the information related to the post-pay type electronic money (differed electronic money), and thus the payment using the information related to the post-pay type electronic money can be made in the transfer destination apparatus. Therefore, by using the transfer destination apparatus, the payment can be continuously made using the information on post-pay type electronic money even in a case in which the electronic value is not enough at the time of payment.

### (Apparatuses Constituting Information Processing System According to Present Embodiment)

Next, the apparatuses constituting the information processing system according to the present embodiment to which the information processing method according to the present embodiment can be applied will be described. An example of a configuration of each of the apparatuses constituting the information processing system 1000 illustrated in FIG. 1 will be described below.

### [I] Information Processing Apparatus 100

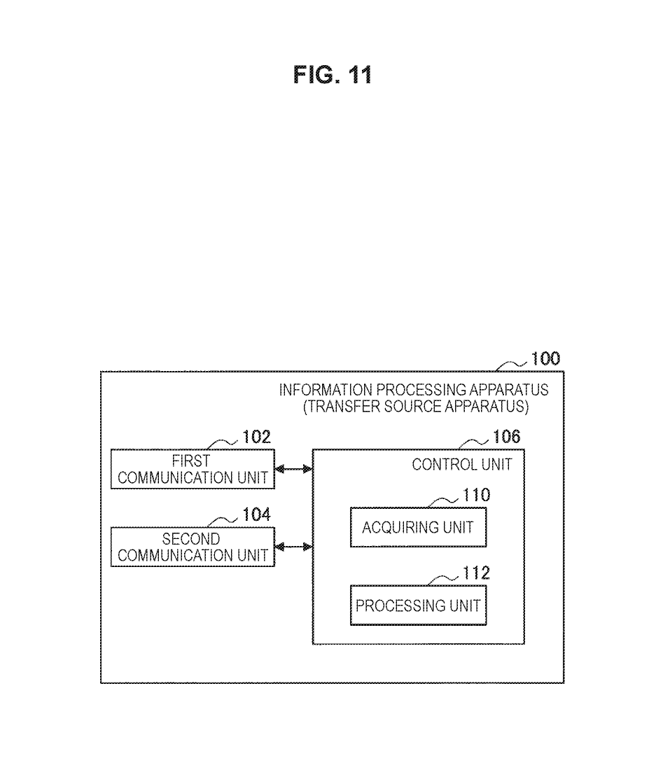

FIG. 11 is a block diagram illustrating an example of a configuration of the information processing apparatus 100 according to the present embodiment. As described above, the information processing apparatus 100 is an apparatus which can be either or both of the electronic value transfer source and an electronic value and the electronic value transfer destination in the information processing system 1000. Therefore, for the sake of convenience, the example in which the information processing apparatus 100 is the transfer source apparatus is illustrated in FIG. 11, but the information processing apparatus 100 can function as the transfer destination apparatus as well.

The information processing apparatus 100 includes, for example, a first communication unit 102, a second communication unit 104, and a control unit 106.

Further, the information processing apparatus 100 may include, for example, a read only memory (ROM) (not illustrated), a random access memory (RAM) (not illustrated), a storage unit (not illustrated), a manipulation unit (not illustrated) that the user can manipulate, a display unit (not illustrated) that displays various screens on the display screen, and the like. The respective components of the information processing apparatus 100 are connected via, for example, a bus as a data transmission path. For example, the information processing apparatus 100 is driven by electric power supplied from an internal power supply such as a battery installed in the information processing apparatus 100, electric power supplied from an external power supply connected thereto, or the like.

The ROM (not illustrated) stores programs and control data such as operation parameters used by the control unit 106. A RAM (not illustrated) temporarily stores programs executed by the control unit 106 and the like.

The storage unit (not illustrated) is a storage unit installed in the information processing apparatus 100, and stores, for example, various data such as data related to the information processing method according to the present embodiment such as the condition information (in a case in which it functions as the transfer destination apparatus) and various kinds of applications. Here, the examples of the storage unit (not illustrated) include a magnetic recording medium such as a hard disk and a non-volatile memory such as a flash memory. Further, the storage unit (not illustrated) may be removable from the information processing apparatus 100.

As the manipulation unit (not illustrated), a manipulation input device to be described later may be used. Further, as the display unit (not illustrated), a display device to be described later may be used.

### [Hardware Configuration Example of Information Processing Apparatus 100]

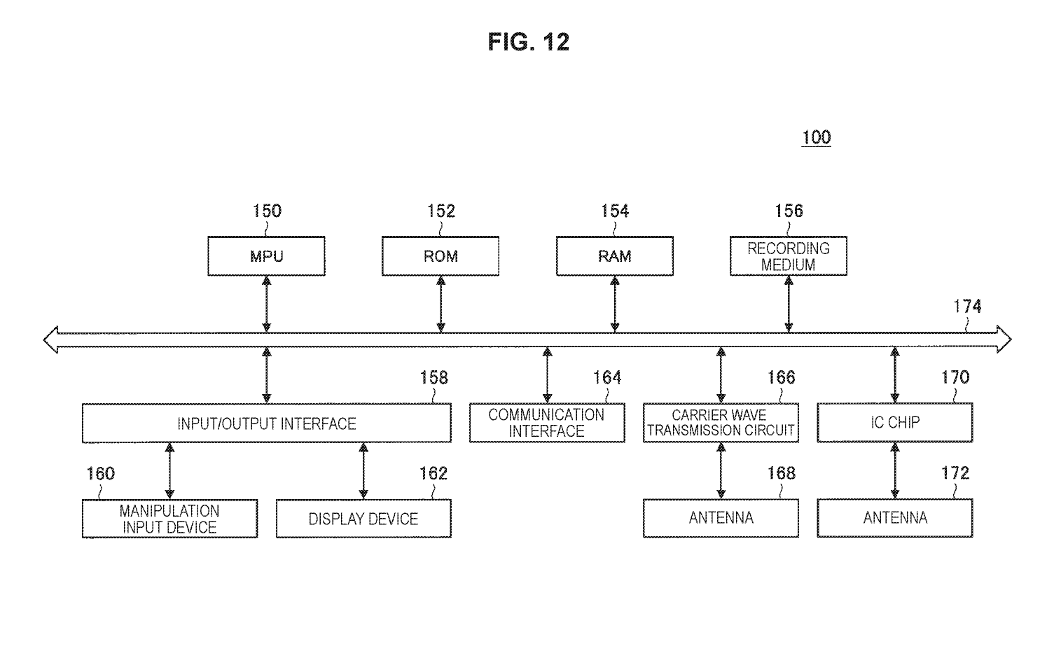

FIG. 12 is an explanatory diagram illustrating an example of a hardware configuration of the information processing apparatus 100 according to the present embodiment. FIG. 12 illustrates an example of a hardware configuration of the information processing apparatus 100 in a case in which NFC communication with other information processing apparatus which can function as the transfer source apparatus or the transfer destination apparatus such as the information processing apparatus 200 is performed.

The information processing apparatus 100 includes, for example, an MPU 150, a ROM 152, a RAM 154, a recording medium 156, an input/output interface 158, a manipulation input device 160, a display device 162, a communication interface 164, a carrier wave transmission circuit 166, an antenna 168, an IC chip 170, and an antenna 172. Further, the components of the information processing apparatus 100 are connected via, for example, a bus 174 serving as a data transmission path.

The MPU 150 is constituted by, for example, one or more processor, various kinds of processing circuits, or the like which are constituted by an operation circuit such as a micro processing unit (MPU) and functions as the control unit 106 that controls the entire information processing apparatus 100. Further, in the information processing apparatus 100, for example, the MPU 150 undertakes the role of an acquiring unit 110 and a processing unit 112 to be described later.

The ROM 152 stores programs used by the MPU 150, control data such as operation parameters, and the like. The RAM 154 temporarily stores, for example, programs executed by the MPU 150.

The recording medium 156 functions as the storage Unit (not illustrated), and stores, for example, various data such as the data related to the information Processing method according to the present embodiment such as the condition information (in a case in which it functions as the transfer destination apparatus) and various kinds of applications. Here, examples of the recording medium 156 include a magnetic recording medium such as a hard disk and a non-volatile memory such as a flash memory. Further, the recording medium 156 may be removable from the information processing apparatus 100.

For example, the input/output interface 158 connects the manipulation input device 160 and the display device 162. The manipulation input device 160 functions as the manipulation unit (not illustrated), and the display device 162 functions as the display unit (not illustrated). Here, examples of the input/output interface 158 include a universal serial bus (USB) terminal, a digital visual interface (DVI) terminal, a high-definition multimedia interface (HDMI) (registered trademark) terminal, and various kinds of processing circuits.

Further, the manipulation input device 160 is installed on, for example, the information processing apparatus 100 and connected with the input/output interface 158 in the information processing apparatus 100. Examples of the manipulation input device 160 include a button, a direction key, a rotary type selector such as a jog dial, or a combination thereof.

Further, the display device 162 is installed on, for example, the information processing apparatus 100 and connected with the input/output interface 158 in the information processing apparatus 100. Examples of the display device 162 include a liquid crystal display (LCD) or an organic electro-luminescence (EL) display. Alternatively, an organic light emitting diode (OLED) display) may be used.

Further, it will be appreciated that the input/output interface 158 can also be connected with an external device such as an external manipulation input device (for example, a keyboard or a mouse) serving as an external apparatus of the information processing apparatus 100 or an external display device. Further, the display device 162 may be a device in which both a display and a user manipulation can be performed such as a touch screen.

The communication interface 164 is communication unit that performs communication of one communication scheme installed in the information processing apparatus 100, and functions as the first communication unit 102 that communicates with an external apparatus such as the first management apparatus 300 or the second management apparatus 400 via the network 500 (or directly). Here, examples of the communication interface 164 include an IEEE 802.15.1 port and a transceiving circuit, an IEEE 802.11 port and a transceiving circuit, and a communication antenna such as an LTE/3G antenna and a radio frequency (RF) circuit.

The carrier wave transmission circuit 166 and the antenna 168 and the IC chip 170 and the antenna 172 are communication units that perform communication of another communication scheme installed in the information processing apparatus 100 and function as the second communication unit 104. The carrier wave transmission circuit 166 and the antenna 168 function as a reader/writer in NFC. Further, the IC chip 170 and the antenna 172 function as a responder in NFC.

The antenna 168 is constituted by, for example, a resonance circuit including a coil having predetermined inductance serving as a transceiving antenna and a capacitor having predetermined capacitance and a demodulation circuit. Further, the antenna 168 receives, for example, a carrier wave of a predetermined frequency such as 13.56 [MHz] and demodulates data and the like transmitted by load modulation or the like from an external apparatus such as the information processing apparatus 200. Further, for example, in a case in which the carrier wave transmission circuit 166 includes a demodulation circuit, the antenna 168 may be constituted by a resonance circuit.

The carrier wave transmission circuit 166 includes, for example, a modulation circuit that performing modulation such as amplitude shift keying (ASK) and an amplification circuit that amplifies an output of the modulation circuit, and causes ca carrier wave including a carrier wave signal to be transmitted from the transceiving antenna of the antenna 168. Further, the carrier wave transmission circuit 166 may include, for example, a demodulation circuit that demodulates a signal received by the antenna 168. For example, the demodulation circuit demodulates the signal received by the antenna 168 by performing develop detection for an amplitude change in a voltage between the modulation circuit (or the amplification circuit) and the resonance circuit of the antenna 168 and binarizing the detected signal. Further, the demodulation circuit can also demodulate the signal received by the antenna 168, for example, by using a phase change in the voltage between the modulation circuit (or the amplification circuit) and the resonance circuit of the antenna 168.

Since the carrier wave transmission circuit 166 is installed, the information processing apparatus 100 has an initiator function in NFC and undertakes the role of the reader/writer. Here, examples of the carrier wave signal transmitted from the antenna 168 by the carrier wave transmission circuit 166 include, for example, a polling signal and signals indicating various kinds of data. Further, for example, transmission of the carrier wave by the carrier wave transmission circuit 166 is controlled by, for example, the MPU 150.

The IC chip 170 and the antenna 172 perform NFC communication with a reader/writer or an external apparatus having a reader/writer function through, for example, a carrier wave of a predetermined frequency such as 13.56 [MHz]. The antenna 172 receives the carrier wave and serves to transmit a response signal. Further, the IC chip 170 demodulates and processes the carrier wave signal transmitted from the external apparatus such as the reader/writer on the basis of the received carrier waves, and causes the response signal to be transmitted by load modulation.

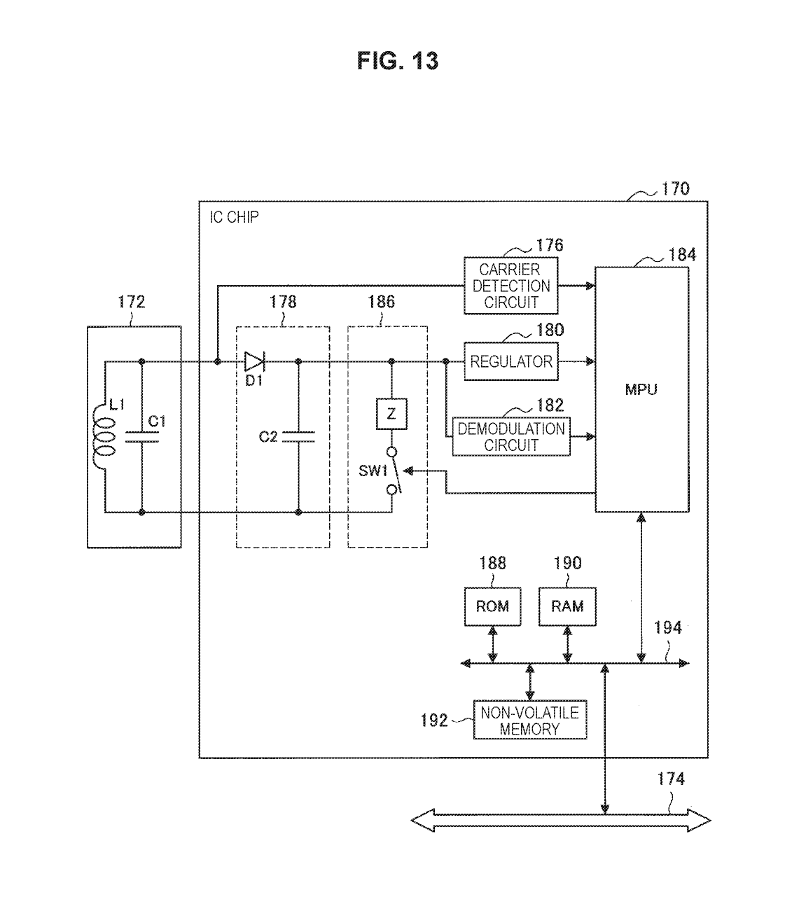

FIG. 13 is an explanatory diagram illustrating an example of configurations of the IC chip 170 and the antenna 172 illustrated in FIG. 12. Further, for example, the information processing apparatus 200 may not have the configuration of the IC chip 170 illustrated in FIG. 13 in the form of an IC chip.

The antenna 172 is constituted by a resonance circuit including, for example, a coil (inductor) L1 having predetermined inductance and a capacitor C1 having predetermined capacitance, and generates an inductive voltage by electromagnetic induction in response to the reception of the carrier wave. Then, the antenna 172 outputs a reception voltage obtained by resonating the inductive voltage at a predetermined resonance frequency. Here, for example, the resonance frequency in the antenna 172 is set in accordance with the frequency of the carrier wave such as 13.56 [MHz]. With the above configuration, the antenna 172 receives the carrier wave and transmits the response signal by load modulation performed in a load modulation circuit 186 included in the IC chip 170.

The IC chip 170 includes a carrier detection circuit 176, a wave detection circuit 178, a regulator 180, a demodulation circuit 182, an MPU 184, and a load modulation circuit 186. Further, although not illustrated in FIG. 13, the IC chip 170 may further include, for example, a protection circuit (not illustrated) for preventing overvoltage and overcurrent from being applied to the MPU 184. Here, as the protection circuit (not illustrated), for example, a clamp circuit constituted by a diode or the like may be used.

Further, the IC chip 170 includes, for example, a ROM 188, a RAM 190, and a non-volatile memory 192. The MPU 184, the ROM 188, the RAM 190, and the non-volatile memory 192 are connected via, for example, a bus 194 serving as a data transmission path. Further, the bus 194 is connected with the bus 174.

The ROM 188 stores programs and control data such as operation parameters used by the MPU 184. The RAM 190 temporarily stores a program executed by the MPU 184, an operation result, an execution state, and the like.

The non-volatile memory 192 stores various data such as encryption key information used for mutual authentication in NFC, the electronic value, various kinds of applications, and the like. Here, examples of the non-volatile memory 192 include an electrically erasable and programmable read only memory (EEPROM), a flash memory, and the like. The non-volatile memory 192 has, for example, has tamper resistance and corresponds to an example of a secure recording medium.

For example, the carrier detection circuit 176 generates a rectangular detection signal on the basis of the reception voltage transferred from the antenna 172, and transfers the detection signal to the MPU 184. Further, for example, the MPU 184 uses the transferred detection signal as a processing clock for data processing. Here, since the detection signal is based on the reception voltage transferred from the antenna 172, the detection signal is synchronized with the frequency of the carrier wave transmitted from the external apparatus such as the reader/writer. Therefore, since the carrier detection circuit 176 is installed, the IC chip 170 can perform processing with the external apparatus such as the reader/writer in synchronization with the external apparatus.

The wave detection circuit 178 rectifies the reception voltage output from the antenna 172. Here, the wave detection circuit 178 includes, for example, a diode D1 and a capacitor C2.

The regulator 180 smooths the reception voltage into a constant voltage, and outputs a drive voltage to the MPU 184. Here, the regulator 180 uses a DC component of the reception voltage as the drive voltage.

The demodulation circuit 182 demodulates the carrier wave signal on the basis of the reception voltage and outputs data corresponding to the carrier wave signal included in the carrier wave (for example, binary data signal of a high level and a low level). Here, the demodulation circuit 182 outputs an AC component of the reception voltage as data.

The MPU 184 is driven using the drive voltage output from the regulator 180 as a power voltage and performs processing of data demodulated in the demodulation circuit 182. Here, the MPU 184 is constituted by one or more processors, various processing circuits, or the like which are constituted by an operation circuit such as an MPU.

Further, the MPU 184 selectively generates a control signal for controlling load modulation related to the response to the external apparatus such as the reader/writer in accordance with a processing result. Then, the MPU 184 selectively outputs the control signal to the load modulation circuit 186.

The load modulation circuit 186 includes, for example, a load Z and a switch SW1, and performs load modulation by selectively connecting (activating) the load Z in accordance with the control signal transferred from the MPU 184. Here, the load Z is constituted by, for example, a resistor having a predetermined resistance value. Further, the switch SW1 is constituted by, for example, a p-channel metal oxide semiconductor field effect transistor (MOSFET) or an n-channel MOSFET.

With the above configuration, the IC chip 170 can process the carrier wave signal received by the antenna 172 and cause the antenna 172 to transmit the response signal by load modulation.

The IC chip 170 and the antenna 172 have, for example, the configurations illustrated in FIG. 13, and perform NFC communicate with the external apparatus such as the reader/writer using a carrier wave of a predetermined frequency. Further, it will be appreciated that the configurations of the IC chip 170 and the antenna 172 according to the present embodiment are not limited to the example illustrated in FIG. 13.

The information processing apparatus 100 has, for example, the configuration illustrated in FIG. 12. Further, the hardware configuration of the information processing apparatus 100 according to the present embodiment is not limited to the configuration illustrated in FIG. 12.

For example, the information processing apparatus 100 may not have the communication interface 164 in a case in which communication of one communication scheme with the external apparatus is performed via an external communication device connected thereto.

Further, in a case in which the information processing apparatus 100 does not function as the reader/writer in NFC, the information processing apparatus 100 may not include the carrier wave transmission circuit 166 and the antenna 168 illustrated in FIG. 12. Further, in a case in which the information processing apparatus 100 does not function as the responder in NFC, the information processing apparatus 100 may not include the IC chip 170 and the antenna 172.

Further, in a case in which the communication performed between the information processing apparatus 100 and another information processing apparatus that can be the transfer source apparatus or the transfer destination apparatus is not NFC communication, the information processing apparatus 100 may not include the carrier wave transmission circuit 166 and the antenna 168 or the IC chip 170 and the antenna 172. Further, in a case in which the communication performed between the information processing apparatus 100 and another information processing apparatus that can be the transfer source apparatus or the transfer destination apparatus is not NFC communication, the information processing apparatus 100 further includes, for example, a communication device that supports communication of another communication scheme such as an infrared communication device.

Further, in a case in which the information processing apparatus 100 performs NFC communication with an external apparatus via an external communication device connected thereto, the information processing apparatus 100 may not include a communication device that supports NFC communication such as the carrier wave transmission circuit 166 and the antenna 168.

Further, the information processing apparatus 100 may be configured not to include, for example, one or more of the recording medium 156, the manipulation input device 160, and the display device 162.

Further, for example, the configuration illustrated in FIG. 12 (or a configuration according to a modified example) may be implemented by one or more ICs.

An example of the configuration of the information processing apparatus 100 will be described with reference back to FIG. 11.

The first communication unit 102 communicates with an external apparatus such as the first management apparatus 300 or the second management apparatus 400 via the network 500 (or directly) through communication of one communication scheme. The communication of one communication scheme in the first communication unit 102 is controlled by, for example, the control unit 106.

Here, examples of the first communication unit 102 include an IEEE 802.15.1 port and a transceiving circuit, an IEEE 802.11 port and a transceiving circuit, and a communication antenna such as an LTE/3G antenna and an RF circuit.

The second communication unit 104 communicates with another information processing apparatus which can be the transfer source apparatus or the transfer destination apparatus such as the information processing apparatus 200 through communication of another communication scheme. The communication of another communication scheme in the second communication unit 104 is controlled by, for example, the control unit 106.

Here, as the second communication unit 104, for example, a communication device that supports NFC such as the carrier wave transmission circuit 166 and the antenna 168 illustrated in FIG. 12, an infrared communication device, or the like may be used.

The control unit 106 is constituted by, for example, an MPU or the like and undertakes the role of controlling the entire information processing apparatus 100. Further, the control unit 106 includes, for example, an acquiring unit 110 and a processing unit 112.

The acquiring unit 110 performs a process of acquiring various kinds of information related to the information processing method according to the present embodiment. The acquiring unit 110, for example, serves as a condition information acquiring unit for acquiring the condition information. Further, for example, the acquiring unit 110 may undertake one or more roles of a “time information acquiring unit that acquires the time information,” a “position information obtaining acquiring unit that acquires the position information,” a “user information acquiring unit that acquires information related to the user,” an “application state acquiring unit that acquires the state of the application,” a “balance information acquiring unit that acquires the information related to the balance of the electronic value associated with the transfer source, and a “deficit acquiring unit that acquires a deficit in a case in which the balance of the transferred electronic value is deficient.” Further, in the information processing apparatus 100, for example, the control unit 106 and the device that acquires various kinds of information may function as the acquiring unit.

In a case in which the information processing apparatus 100 functions as the transfer source apparatus, the processing unit 112 performs various kinds of processes in the information processing apparatus 100 functioning as the transfer source apparatus, for example, as illustrated in FIGS. 2, 4, 6, 8, and 9.

Further, in a case in which the information processing apparatus 100 functions as the transfer destination apparatus, the processing unit 112 plays a leading role in performing the process related to the information processing method according to the present embodiment. The processing unit 112 can control the function related to the use of the electronic value on the basis of the condition information. Further, the processing unit 112 can also control the credit function on the basis of the credit condition information.

For example, since the processing unit 112 is installed, the control unit 106 can undertake a leading role in the process related to the transfer source apparatus and the process related to the information processing method according to the present embodiment (for example, the function control process).

For example, with the configuration illustrated in FIG. 11, the information processing apparatus 100 performs the process related to the transfer source apparatus and the process related to the information processing method according to the present embodiment (for example, the function control process).

Accordingly, the information processing apparatus 100 can function as either or both of the transfer source apparatus and the transfer destination apparatus.

Further, in a case in which the information processing apparatus 100 functions as the transfer destination apparatus, the information processing apparatus 100 can control the use of the electronic value transferred from the transfer source.

Further, in a case in which the information processing apparatus 100 functions as the transfer destination apparatus, the information processing apparatus 100 can achieve the effect obtain by performing the process related to the information processing method according to the present embodiment described above.

Further, the configuration of the information processing apparatus 100 according to the present embodiment is not limited to the configuration illustrated in FIG. 11.

For example, the information processing apparatus 100 according to the present embodiment may include either or both of the acquiring unit 110 and the processing unit 112 illustrated in FIG. 11 separately from the control unit 106 (for example, it may be implemented by another processing circuit). Further, either or both of the acquiring unit 110 and the processing unit 112 may be implemented by a plurality of processing circuits, and the functions may be distributedly performed by a plurality of processing circuits.

Further, in a case in which the information processing apparatus 100 according to the present embodiment functions as the transfer destination apparatus, the configuration for implementing the process related to the information processing method according to the present embodiment is not limited to the configuration illustrated in FIG. 11, and a configuration corresponding to a way of dividing the process related to the information processing method in accordance with the present embodiment can be provided.

Further, in a case in which the information processing apparatus 100 according to the present embodiment functions as the transfer source apparatus, the information processing apparatus 100 according to the present embodiment may be configured not to include the acquiring unit 110.

Further, for example, in a case in which the information processing apparatus according to the present embodiment communicates with the external apparatus via an external communication device having a similar function and configuration as that of the first communication unit 102, the information processing apparatus according to the present embodiment may not include the first communication unit 102.

Further, for example, in a case in which the information processing apparatus according to the present embodiment communicates with the external apparatus via an external communication device having a similar function and configuration as that of the second communication unit 104, the information processing apparatus according to the present embodiment may not include the second communication unit 104.

### [II] Information Processing Apparatus 200

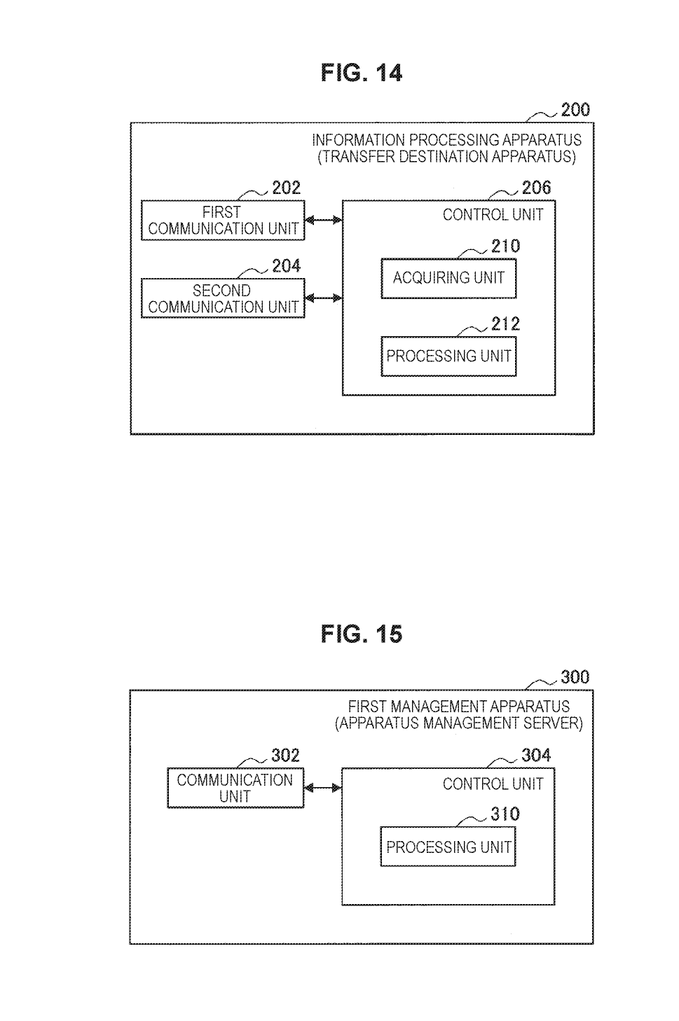

FIG. 14 is a block diagram illustrating an example of a configuration of the information processing apparatus 200 according to the present embodiment. As described above, the information processing apparatus 200 is an apparatus which can be either or both of the electronic value transfer source and an electronic value and the electronic value transfer destination in the information processing system 1000. Therefore, for the sake of convenience, the example in which the information processing apparatus 200 is the transfer destination apparatus is illustrated in FIG. 14, but the information processing apparatus 200 can function as the transfer source apparatus as well.

The information processing apparatus 200 includes, for example, a first communication unit 202, a second communication unit 204, and a control unit 206.

Further, the information processing apparatus 200 may include, for example, a ROM (not illustrated), a RAM (not illustrated), a storage unit (not illustrated), a manipulation unit (not illustrated) that the user can manipulate, a display unit (not illustrated) that displays various screens on the display screen, and the like. The respective components of the information processing apparatus 200 are connected via, for example, a bus as a data transmission path. For example, the information processing apparatus 200 is driven by electric power supplied from an internal power supply such as a battery installed in the information processing apparatus 200, electric power supplied from an external power supply connected thereto, or the like.

The ROM (not illustrated) stores programs and control data such as operation parameters used by the control unit 206. A RAM (not illustrated) temporarily stores programs executed by the control unit 206 and the like.

The storage unit (not illustrated) is a storage unit installed in the information processing apparatus 200, and stores, for example, various data such as data related to the information processing method according to the present embodiment such as the condition information (in a case in which it functions as the transfer destination apparatus) and various kinds of applications. Here, the examples of the storage unit (not illustrated) include a magnetic recording medium such as a hard disk and a non-volatile memory such as a flash memory. Further, the storage unit (not illustrated) may be removable from the information processing apparatus 200.

As the manipulation unit (not illustrated), the above-described manipulation input device may be used. Further, as the display unit (not illustrated), the above-described display device may be used.

### [Hardware Configuration Example of Information Processing Apparatus 200]

The information processing apparatus 200 can have a hardware configuration (including a modified example) similar to that of the information processing apparatus 100 illustrated with reference to FIG. 12.

The first communication unit 202 communicates with an external apparatus such as the first management apparatus 300 or the second management apparatus 400 via the network 500 (or directly) through communication of one communication scheme. The communication of one communication scheme in the first communication unit 202 is controlled by, for example, the control unit 206.

Here, examples of the first communication unit 202 include an IEEE 802.15.1 port and a transceiving circuit, an IEEE 802.11 port and a transceiving circuit, and a communication antenna such as an LTE/3G antenna and an RF circuit.

The second communication unit 204 communicates with another information processing apparatus which can be the transfer source apparatus or the transfer destination apparatus such as the information processing apparatus 100 through communication of another communication scheme. The communication of another communication scheme in the second communication unit 204 is controlled by, for example, the control unit 206.

Here, as the second communication unit 204, for example, a communication device that supports NFC such as the carrier wave transmission circuit 166 and the antenna 168 illustrated in FIG. 12, an infrared communication device, or the like may be used.

The control unit 206 is constituted by, for example, an MPU or the like and undertakes the role of controlling the entire information processing apparatus 200. Further, the control unit 206 includes, for example, an acquiring unit 210 and a processing unit 212.

The acquiring unit 210 performs a process of acquiring various kinds of information related to the information processing method according to the present embodiment. The acquiring unit 210, for example, serves as a condition information acquiring unit for acquiring the condition information. Further, for example, the acquiring unit 210 may undertake one or more roles of a “time information acquiring unit that acquires the time information,” a “position information obtaining acquiring unit that acquires the position information,” a “user information acquiring unit that acquires information related to the user,” an “application state acquiring unit that acquires the state of the application,” a “balance information acquiring unit that acquires the information related to the balance of the electronic value associated with the transfer source, and a “deficit acquiring unit that acquires a deficit in a case in which the balance of the transferred electronic value is deficient.” Further, in the information processing apparatus 200, for example, the control unit 206 and the device that acquires various kinds of information may function as the acquiring unit.

In a case in which the information processing apparatus 200 functions as the transfer source apparatus, the processing unit 212 performs various kinds of processes in the information processing apparatus 100 functioning as the transfer source apparatus, for example, as illustrated in FIGS. 2, 4, 6, 8, and 9.

Further, in a case in which the information processing apparatus 200 functions as the transfer destination apparatus, the processing unit 212 plays a leading role in performing the process related to the information processing method according to the present embodiment. The processing unit 212 can control the function related to the use of the electronic value on the basis of the condition information. Further, the processing unit 212 can also control the credit function on the basis of the credit condition information.

For example, since the processing unit 212 is installed, the control unit 206 can undertake a leading role in the process related to the transfer source apparatus and the process related to the information processing method according to the present embodiment (for example, the function control process).

For example, with the configuration illustrated in FIG. 14, the information processing apparatus 100 performs the process related to the transfer source apparatus and the process related to the information processing method according to the present embodiment (for example, the function control process).

Accordingly, the information processing apparatus 200 can function as either or both of the transfer source apparatus and the transfer destination apparatus.

Further, in a case in which the information processing apparatus 200 functions as the transfer destination apparatus, the information processing apparatus 100 can control the use of the electronic value transferred from the transfer source.

Further, in a case in which the information processing apparatus 200 functions as the transfer destination apparatus, the information processing apparatus 100 can achieve the effect obtain by performing the process related to the information processing method according to the present embodiment described above.

Further, the configuration of the information processing apparatus 200 according to the present embodiment is not limited to the configuration illustrated in FIG. 14.

For example, the information processing apparatus 200 according to the present embodiment may include the processing unit 212 illustrated in FIG. 14 separately from the control unit 206 (it may be implemented by, for example, another processing circuit). Further, the processing unit 212 may be implemented by a plurality of processing circuits, and the respective functions may be distributedly performed by a plurality of processing circuits.

Further, in a case in which the information processing apparatus 200 according to the present embodiment functions as the transfer destination apparatus, the configuration for implementing the process related to the information processing method according to the present embodiment is not limited to the configuration illustrated in FIG. 14, and a configuration corresponding to a way of dividing the process related to the information processing method in accordance with the present embodiment can be provided.

Further, in a case in which the information processing apparatus 200 according to the present embodiment functions as the transfer source apparatus, the information processing apparatus 200 according to the present embodiment may be configured not to include the acquiring unit 210.

Further, for example, in a case in which the information processing apparatus according to the present embodiment communicates with the external apparatus via an external communication device having a similar function and configuration as that of the first communication unit 202, the information processing apparatus according to the present embodiment may not include the first communication unit 202.

Further, for example, in a case in which the information processing apparatus according to the present embodiment communicates with the external apparatus via an external communication device having a similar function and configuration as that of the second communication unit 204, the information processing apparatus according to the present embodiment may not include the second communication unit 204.

### [III] First Management Apparatus 300

FIG. 15 is a block diagram illustrating an example of a configuration of the first management apparatus 300 according to the present embodiment. The first management apparatus 300 includes, for example, a communication unit 302 and a control unit 304.

Further, the first management apparatus 300 may include, for example, a ROM (not illustrated), a RAM (not illustrated), a storage unit (not illustrated), a manipulation unit (not illustrated) that the user of the first management apparatus 300 can manipulate, a display unit (not illustrated) that displays various screens on the display screen, and the like. The respective components of the first management apparatus 300 are connected via, for example, a bus serving as a data transmission path. The first management apparatus 300 is driven by electric power supplied from an internal power supply such as a battery installed in the first management apparatus 300, electric power supplied from an external power supply connected thereto, or the like.

The ROM (not illustrated) stores programs and control data such as operation parameters used by the control unit 304. A RAM (not illustrated) temporarily stores programs executed by the control unit 304 and the like.

The storage unit (not illustrated) is a storage unit installed in the first management apparatus 300, and stores, for example, various data such as data related to the management of the apparatus such as a database related to the management of the apparatus or various kinds of applications. Here, examples of the storage unit (not illustrated) include a magnetic recording medium such as a hard disk and a non-volatile memory such as a flash memory. Further, the storage unit (not illustrated) may be removable from the first management apparatus 300.

As the manipulation unit (not illustrated), a manipulation input device 360 to be described later may be used. Further, as the display unit (not illustrated), a display device 362 to be described later may be used.

### [Hardware Configuration Example of First Management Apparatus 300]

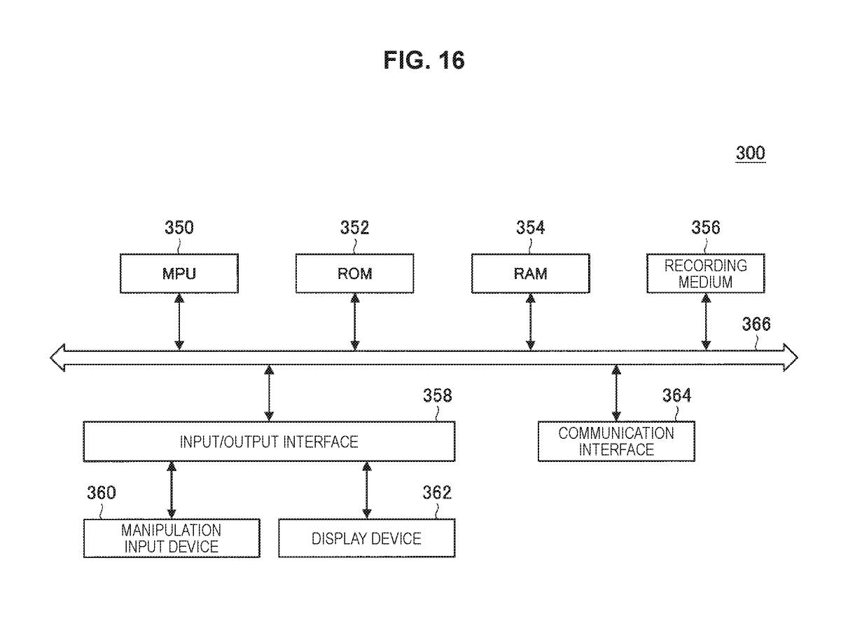

FIG. 16 is an explanatory diagram illustrating an example of a hardware configuration of a first management apparatus 300 according to the present embodiment. The first management apparatus 300 includes, for example, an MPU 350, a ROM 352, a RAM 354, a recording medium 356, an input/output interface 358, a manipulation input device 360, a display device 362, and a communication interface 364. Further, the components of the first management apparatus 300 are connected via, for example, a bus 366 serving as a data transmission path.

The MPU 350 is constituted by, for example, one or more processor, various kinds of processing circuits, or the like which are constituted by an operation circuit such as a micro processing unit (MPU) and functions as the control unit 304 that controls the entire first management apparatus 300. Further, in the first management apparatus 300, for example, the MPU 350 undertakes the role of a processing unit 310 to be described later. Further, the processing unit 310 may be constituted by a dedicated (or general-purpose) circuit capable of implementing the processing of the processing unit 310 (for example, a processor separate from the MPU 150).

The ROM 352 stores programs and control data and the like such as operation parameters used by the MPU 350. A RAM 354 temporarily stores programs executed by the MPU 350 and the like.

The recording medium 356 functions as a storage unit (not illustrated), and stores, for example, various data such as data related to the management of the apparatus such as a database related to the management of the apparatus or various kinds of applications. Here, examples of the recording medium 356 include a magnetic recording medium such as a hard disk and a non-volatile memory such as a flash memory. Further, the recording medium 356 may be removable from the first management apparatus 300.

For example, the input/output interface 358 connects the manipulation input device 360 or the display device 362. The manipulation input device 360 functions as the manipulation unit (not illustrated), and the display device 362 functions as the display unit (not illustrated). Here, examples of the input/output interface 358 include a USB terminal, a DVI terminal, an HDMI (registered trademark) terminal, and various kinds of processing circuits.

Further, the manipulation input device 360 is installed on, for example, the first management apparatus 300 and connected with the input/output interface 358 in the first management apparatus 300. Examples of the manipulation input device 360 include a button, a direction key, a rotary type selector such as a jog dial, or a combination thereof.

Further, the display device 362 is installed on, for example, the first management apparatus 300 and connected with the input/output interface 358 inside the first management apparatus 300. Examples of the display device 362 include a liquid crystal display and an organic EL display.

Further, it will be appreciated that the input/output interface 358 can also be connected with an external device such as an external manipulation input device (for example, a keyboard or a mouse) of the first management apparatus 300 or an external display device. Further, the display device 362 may be a device in which both a display and a user manipulation can be performed such as a touch panel.

The communication interface 364 is a communication unit installed in the first management apparatus 300, and functions as the communication unit 302 that wireless or wired communicates with the external apparatus such as the information processing apparatus 100, the information processing apparatus 200, or the second management apparatus 400 via the network 500 (or directly). Here, examples of the communication interface 364 include a communication antenna and an RF circuit (wireless communication), an IEEE 802.15.1 port and a transceiving circuit (wireless communication), an IEEE 802.11 port and a transceiving circuit (wireless communication), and an LAN terminal and a transceiving circuit (wired communication).

For example, with the configuration illustrated in FIG. 16, the first management apparatus 300 manages the information processing apparatus 100, the information processing apparatus 200, and the like. Further, for example, with the configuration illustrated in FIG. 16, the first management apparatus 300 sets the condition information, the credit condition information, and the like in the information processing apparatus functioning as the transfer destination apparatus as described above illustrated in FIGS. 2 and 9.

Further, the hardware configuration of the first management apparatus 300 according to the present embodiment is not limited to the configuration illustrated in FIG. 16.

For example, the first management apparatus 300 may not include the communication interface 364 in a case in which communicating with an external apparatus via an external communication device connected thereto. Further, the communication interface 364 may be configured to communicate with one or more external apparatuses in accordance with a plurality of communication schemes.

Further, the first management apparatus 300 may have, for example, a configuration not including the recording medium 356, the manipulation input device 360, and the display device 362.

Further, for example, part or all of the configuration illustrated in FIG. 16 (or a configuration according to a modified example) may be implemented by one or more ICs.

An example of the configuration of the first management apparatus 300 will be described with reference back to FIG. 15. The communication unit 302 is a communication unit installed in the first management apparatus 300, and performs wireless ow wired communicates with the external apparatus such as the information processing apparatus 100, the information processing apparatus 200, the second management apparatus 400, or the like via the network 500 (or directly). Further, the communication of the communication unit 302 is controlled by, for example, the control unit 304.

Here, as the communication unit 302, for example, a communication antenna and an RF circuit or a LAN terminal and a transceiving circuit may be used, but the configuration of the communication unit 302 is not limited to this example. For example, the communication unit 302 can have a configuration corresponding to an arbitrary standard capable of performing communication such as a USB terminal and a transceiving circuit, or an arbitrary configuration capable of communicating with the external apparatus via the network 500. Further, the communication unit 302 may be configured to communicate with one or two or more external apparatuses or the like in accordance with a plurality of communication schemes.

The control unit 304 is constituted by, for example, an MPU or the like and undertakes the role of controlling the entire first management apparatus 300. Further, the control unit 304 includes, for example, a processing unit 310.

The processing unit 310 performs, for example, various kinds of processes in the first management apparatus 300 as illustrated in FIGS. 2, 4, 6, 8, and 9, and manages the information processing apparatus functioning either or both of the transfer source apparatus and the transfer destination apparatus. Further, as illustrated in FIGS. 2 and 9, the processing unit 310 sets the condition information, the credit condition information, and the like in the information processing apparatus functioning as the transfer destination apparatus.

For example, since the processing unit 310 is installed, the control unit 304 manages the information processing apparatus functioning as either or both of the transfer source apparatus and the transfer destination apparatus.

For example, with the configuration illustrated in FIG. 15, the first management apparatus 300 manages the information processing apparatus functioning as either or both of the transfer source apparatus and the transfer destination apparatus.

Further, the configuration of the first management apparatus 300 according to the present embodiment is not limited to the configuration illustrated in FIG. 15.

For example, the first management apparatus 300 according to the present embodiment may include the processing unit 310 illustrated in FIG. 15 separately from the control unit 304 (it may be implemented by, for example, another processing circuit). Further, the processing unit 310 may be implemented by a plurality of processing circuits, and the respective functions may be distributedly performed by a plurality of processing circuits.

Further, for example, in a case in which the first management apparatus 300 communicates with an external apparatus via an external communication device having a function and configuration similar to the communication unit 302, the first management apparatus 300 may not include the communication unit 302.

### [IV] Second Management Apparatus 400

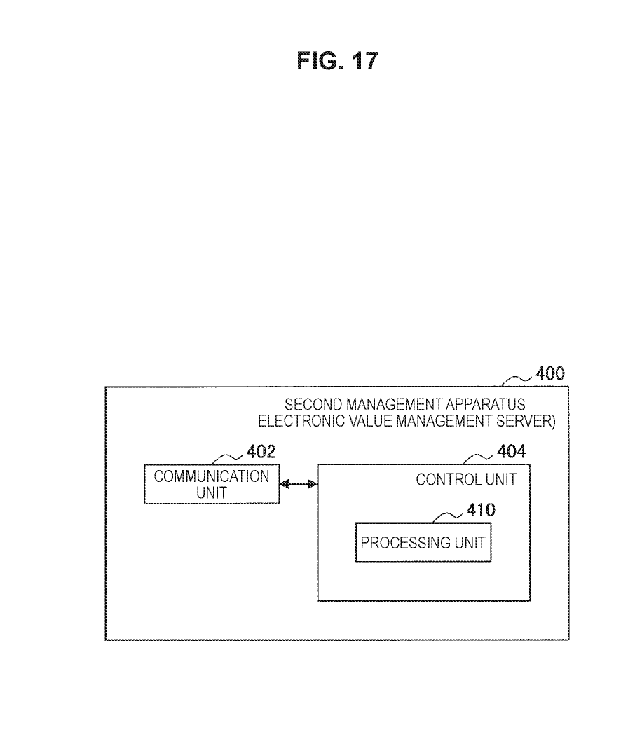

FIG. 17 is a block diagram illustrating an example of a configuration of the second management apparatus 400 according to the present embodiment. The second management apparatus 400 includes, for example, a communication unit 402 and a control unit 404.

Further, the second management apparatus 400 may include, for example, a ROM (not illustrated), a RAM (not illustrated), a storage unit (not illustrated), a manipulation unit (not illustrated) that the user of the second management apparatus 400 can manipulate, a display unit (not illustrated) that displays various screens on the display screen, and the like. The respective components of the second management apparatus 400 are connected via, for example, a bus serving as a data transmission path. The second management apparatus 400 is driven by electric power supplied from an internal power supply such as a battery installed in the second management apparatus 400, electric power supplied from an external power supply connected thereto, or the like.

The ROM (not illustrated) stores programs and control data such as operation parameters used by the control unit 404. A RAM (not illustrated) temporarily stores programs executed by the control unit 404 and the like.

The storage unit (not illustrated) is a storage unit installed in the second management apparatus 400, and stores, for example, various data such as data related to the management of the electronic value such as a database related to the management of the electronic value or various kinds of applications. Here, examples of the storage unit (not illustrated) include a magnetic recording medium such as a hard disk and a non-volatile memory such as a flash memory. Further, the storage unit (not illustrated) may be removable from the second management apparatus 400.

As the manipulation unit (not illustrated), the above-described manipulation input device 360 may be used. Further, as the display unit (not illustrated), the above-described display device 362 may be used.

### [Hardware Configuration Example of Second Management Apparatus 400]

The second management apparatus 400 can have a hardware configuration (including a modified example) similar to that of the first management apparatus 300 illustrated with reference to FIG. 16.

The communication unit 402 is a communication unit installed in the second management apparatus 400, and performs wireless ow wired communicates with the external apparatus such as the information processing apparatus 100, the information processing apparatus 200, the first management apparatus 300, or the like via the network 500 (or directly). Further, the communication of the communication unit 402 is controlled by, for example, the control unit 404.

Here, as the communication unit 402, for example, a communication antenna and an RF circuit or a LAN terminal and a transceiving circuit may be used, but the configuration of the communication unit 402 is not limited to this example. For example, the communication unit 402 can have a configuration corresponding to an arbitrary standard capable of performing communication such as a USB terminal and a transceiving circuit, or an arbitrary configuration capable of communicating with the external apparatus via the network 500. Further, the communication unit 402 may be configured to communicate with one or two or more external apparatuses or the like in accordance with a plurality of communication schemes.

The control unit 404 is constituted by, for example, an MPU or the like and undertakes the role of controlling the entire second management apparatus 400. Further, the control unit 404 includes, for example, a processing unit 410.

The processing unit 410 performs, for example, various kinds of processes in the second management apparatus 400 illustrated in FIGS. 2, 4, 6, 8, and 9, and manages the electronic value. The processing unit 410 causes the electronic value to be transferred from one apparatus to the other apparatus, for example, by performing the process of step S112 and the process of step S114 of FIG. 2, the process of step S214 and the process of step S216 of FIG. 4, or the process of step S308 and the process of step S310 of FIG. 6. With the processing in the processing unit 410, the information processing system 1000 causes the electronic value to be transferred from the transfer source apparatus to the transfer destination apparatus (or from the transfer destination apparatus to the transfer source apparatus) through the second management apparatus 400.

The control unit 404 includes, for example, the processing unit 310 and manages the electronic value.

The second management apparatus 400 manages the electronic value with, for example, the configuration illustrated in FIG. 17.

Further, the configuration of the second management apparatus 400 according to the present embodiment is not limited to the configuration illustrated in FIG. 17.

For example, the second management apparatus 400 according to the present embodiment may include the processing unit 410 illustrated in FIG. 17 separately from the control unit 404 (it may be implemented by, for example, another processing circuit). Further, the processing unit 410 may be implemented by a plurality of processing circuits, and the respective functions may be distributedly performed by a plurality of processing circuits.

Further, for example, in a case in which the second management apparatus 400 communicates with an external apparatus via an external communication device having a function and configuration similar to the communication unit 402, the second management apparatus 400 may not include the communication unit 402.

The information processing apparatus has been described above as the apparatus that can function as either or both of the transfer source apparatus and transfer destination apparatus according to the present embodiment constituting the information processing system according to the present embodiment, but the present embodiment is not limited to such a form. For example, the present embodiment may be applied to various devices capable of performing the process related to the information processing method according to the present embodiment such as a “communication apparatus such as a smart phone,” a “computer such as a personal computer (PC),” a “tablet type apparatus,” a “game machine,” and an arbitrary wearable apparatus worn on the body of the user for use such as a “watch type apparatus” or a “bracelet type apparatus.” Further, the present embodiment can also be applied to, for example, a processing IC which can be incorporated into the devices described above.

The first management apparatus has been described as the apparatus constituting the information processing system according to the present embodiment, but the present embodiment is not restricted to such a form. The present embodiment can be applied to, for example, various devices capable of performing various kinds of processes in the first management apparatus illustrated in FIGS. 2, 4, 6, 8, and 9 such as a computer such as a PC or a server. Further, the present embodiment can also be applied to, for example, a processing IC which can be incorporated into the devices described above.

The second management apparatus has been described as the apparatus constituting the information processing system according to the present embodiment, but the present embodiment is not restricted to such a form. The present embodiment can be applied to, for example, various devices capable of performing various kinds of processes in the second management apparatus illustrated in FIGS. 2, 4, 6, 8, and 9 such as a computer such as a PC or a server. Further, the present embodiment can also be applied to, for example, a processing IC which can be incorporated into the devices described above.

### (Program According to Present Embodiment)

A computer program causing a computer system to function as the information processing apparatus according to the present embodiment (for example, a program capable of executing the process related to the information processing method according to the present embodiment such as the function control process according to the present embodiment) may be executed by a processor or the like in the computer system and control the use of the electronic value transferred from the transfer source. Here, the computer system according to the present embodiment may include a single computer or a plurality of computers. The computer system according to the present embodiment performs a series of processes related to the information processing method according to the present embodiment.

Further, as the program causing the computer system to function as the information processing apparatus according to the present embodiment by the processor or the like in the computer system, the effects achieved by the process related to the information processing method according to the present embodiment can be obtained.

The preferred embodiment(s) of the present disclosure has/have been described above with reference to the accompanying drawings, whilst the present disclosure is not limited to the above examples. A person skilled in the art may find various alterations and modifications within the scope of the appended claims, and it should be understood that they will naturally come under the technical scope of the present disclosure.

For example, in the above example, the program (computer program) causing the computer system to function as the information processing apparatus according to the present embodiment has been described as being provided, but in the present embodiment, further, a recording medium having the program stored therein can be provided together.

The above-described configurations indicate an example of the present embodiment and obviously belong to the technical scope of the present disclosure.

Further, the effects described in this specification are merely illustrative or exemplified effects, and are not limitative. That is, with or in the place of the above effects, the technology according to the present disclosure may achieve other effects that are clear to those skilled in the art from the description of this specification.

Additionally, the present technology may also be configured as below.
(1)

An information processing apparatus, including:

a condition information acquiring unit configured to acquire condition information indicating a use condition of an electronic value transferred from a transfer source; and

a processing unit configured to determine whether or not the transferred electronic value is usable on a basis of the condition information and control a function related to use of the transferred electronic value on a basis of a determination result.
(2)

The information processing apparatus according to (1), in which the function related to the use of the electronic value is a communication function used for the use of the electronic value, and

the processing unit restricts at least a part of the communication function in a case in which it is determined that the transferred electronic value is not usable.
(3)

The information processing apparatus according to (2), in which the processing unit restricts communication with a predetermined apparatus by not performing a normal response or by performing an error response to a command transmitted from the predetermined apparatus.
(4)

The information processing apparatus according to (2) or (3), in which, in a case in which communication with a predetermined apparatus is performed when the function related to the use of the electronic value is restricted,

the processing unit cancels the restriction of the function related to the use of the electronic value.
(5)

The information processing apparatus according to (4), in which the predetermined apparatus is an apparatus having authentication information corresponding to the information processing apparatus.
(6)

The information processing apparatus according to any one of (1) to (5), in which the condition information includes a condition related to an effective period of the transferred electronic value,

the information processing apparatus includes a time information acquiring unit configured to acquire time information related to a time at which the electronic value is used, and the processing unit determines whether or not the transferred electronic value is usable on a basis of the time information and the condition related to the effective period.
(7)

The information processing apparatus according to any one of (1) to (6), in which the condition information includes a condition related to a place,

the information processing apparatus includes a position information acquiring unit configured to acquire position information related to the information processing apparatus, and the processing unit determines whether or not the transferred electronic value is usable on a basis of the position information and the condition related to the place.
(8)

The information processing apparatus according to any one of (1) to (7), in which the condition information includes a condition related to an authorized user,

the information processing apparatus includes a user information acquiring unit configured to acquire information related to a user of the information processing apparatus, and

the processing unit determines whether or not the transferred electronic value is usable on a basis of the information related to the user and the condition related to the authorized user.
(9)

The information processing apparatus according to any one of (1) to (8), in which the condition information includes a condition related to a state of a predetermined application,

the information processing apparatus includes an application state acquiring unit configured to acquire a state of an application, and

the processing unit determines whether or not the transferred electronic value is usable on a basis of the state of the predetermined application and the condition related to the state of the predetermined application.
(10)

The information processing apparatus according to any one of (1) to (9), in which the condition information includes a use condition related to a credit function, and

the processing unit causes a transfer request for the electronic value to be transmitted on a basis of the use condition related to the credit function in a case in which a balance of the transferred electronic value is deficient.
(11)

The information processing apparatus according to (10), in which the use condition related to the credit function includes information related to an amount of money of a transferable electronic value.
(12)

The information processing apparatus according to any one of (1) to (11), in which the condition information is set by a first management apparatus configured to manage the information processing apparatus and an apparatus associated with the transfer source.
(13)

The information processing apparatus according to any one of (1) to (12), in which the electronic value is transferred to the information processing apparatus from the apparatus associated with the transfer source via a second management apparatus configured to manage the electronic value.
(14)

The information processing apparatus according to (13), further including:

a balance information acquiring unit configured to acquire information related to a balance of the electronic value associated with the transfer source via the second management apparatus; and

a deficit acquiring unit configured to acquire a deficit in a case in which a balance of the transferred electronic value is deficient,

in which the processing unit determines whether or not an electronic value exceeding the balance of the transferred electronic value is usable on a basis of the information related to the balance and the deficit of the electronic value.
(15)

A management apparatus configured to perform communication with an information processing apparatus to which an electronic value is transferred from an apparatus associated with a transfer source, and cause the information processing apparatus to set condition information indicating a use condition of the electronic value transferred from the apparatus associated with the transfer source.
(16)

An information processing method that is executed by an information processing apparatus, the information processing method including:

a step of acquiring condition information indicating a use condition of an electronic value transferred from a transfer source; and

a step of determining whether or not the transferred electronic value is usable on a basis of the condition information and controlling a function related to use of the transferred electronic value on a basis of a determination result.
(17)

An information processing system, including:

a first information processing apparatus which is a transfer source of an electronic value; and

a second information processing apparatus which is a transfer destination of the electronic value,

in which the second information processing apparatus includes
a condition information acquiring unit configured to acquire condition information indicating a use condition of an electronic value transferred from the first information processing apparatus, and
a processing unit configured to determine whether or not the transferred electronic value is usable on a basis of the condition information and control a function related to use of the transferred electronic value on a basis of a determination result.

### REFERENCE SIGNS LIST

100, 200 information processing apparatus
102, 202 first communication unit
104, 204 second communication unit
106, 206, 304, 404 control unit
110, 210 acquiring unit
112, 212, 310, 410 processing unit
300 first management apparatus
302, 402 communication unit
400 second management apparatus
500 network
1000 information processing system

1. An information processing apparatus, comprising:
a condition information acquiring unit configured to acquire condition information indicating a use condition of an electronic value transferred from a transfer source; and
a processing unit configured to determine whether or not the transferred electronic value is usable on a basis of the condition information and control a function related to use of the transferred electronic value on a basis of a determination result.

2. The information processing apparatus according to claim 1, wherein the function related to the use of the electronic value is a communication function used for the use of the electronic value, and
the processing unit restricts at least a part of the communication function in a case in which it is determined that the transferred electronic value is not usable.

3. The information processing apparatus according to claim 2, wherein the processing unit restricts communication with a predetermined apparatus by not performing a normal response or by performing an error response to a command transmitted from the predetermined apparatus.

4. The information processing apparatus according to claim 2, wherein, in a case in which communication with a predetermined apparatus is performed when the function related to the use of the electronic value is restricted,
the processing unit cancels the restriction of the function related to the use of the electronic value.

5. The information processing apparatus according to claim 4, wherein the predetermined apparatus is an apparatus having authentication information corresponding to the information processing apparatus.

6. The information processing apparatus according to claim 1, wherein the condition information includes a condition related to an effective period of the transferred electronic value,
the information processing apparatus comprises a time information acquiring unit configured to acquire time information related to a time at which the electronic value is used, and
the processing unit determines whether or not the transferred electronic value is usable on a basis of the time information and the condition related to the effective period.

7. The information processing apparatus according to claim 1, wherein the condition information includes a condition related to a place,
the information processing apparatus comprises a position information acquiring unit configured to acquire position information related to the information processing apparatus, and
the processing unit determines whether or not the transferred electronic value is usable on a basis of the position information and the condition related to the place.

8. The information processing apparatus according to claim 1, wherein the condition information includes a condition related to an authorized user,
the information processing apparatus comprises a user information acquiring unit configured to acquire information related to a user of the information processing apparatus, and
the processing unit determines whether or not the transferred electronic value is usable on a basis of the information related to the user and the condition related to the authorized user.

9. The information processing apparatus according to claim 1, wherein the condition information includes a condition related to a state of a predetermined application,
the information processing apparatus comprises an application state acquiring unit configured to acquire a state of an application, and
the processing unit determines whether or not the transferred electronic value is usable on a basis of the state of the predetermined application and the condition related to the state of the predetermined application.

10. The information processing apparatus according to claim 1, wherein the condition information includes a use condition related to a credit function, and
the processing unit causes a transfer request for the electronic value to be transmitted on a basis of the use condition related to the credit function in a case in which a balance of the transferred electronic value is deficient.

11. The information processing apparatus according to claim 10, wherein the use condition related to the credit function includes information related to an amount of money of a transferable electronic value.

12. The information processing apparatus according to claim 1, wherein the condition information is set by a first management apparatus configured to manage the information processing apparatus and an apparatus associated with the transfer source.

13. The information processing apparatus according to claim 1, wherein the electronic value is transferred to the information processing apparatus from the apparatus associated with the transfer source via a second management apparatus configured to manage the electronic value.

14. The information processing apparatus according to claim 13, further comprising:
a balance information acquiring unit configured to acquire information related to a balance of the electronic value associated with the transfer source via the second management apparatus; and
a deficit acquiring unit configured to acquire a deficit in a case in which a balance of the transferred electronic value is deficient,
wherein the processing unit determines whether or not an electronic value exceeding the balance of the transferred electronic value is usable on a basis of the information related to the balance and the deficit of the electronic value.

15. A management apparatus configured to perform communication with an information processing apparatus to which an electronic value is transferred from an apparatus associated with a transfer source, and cause the information processing apparatus to set condition information indicating a use condition of the electronic value transferred from the apparatus associated with the transfer source.

16. An information processing method that is executed by an information processing apparatus, the information processing method comprising:
a step of acquiring condition information indicating a use condition of an electronic value transferred from a transfer source; and
a step of determining whether or not the transferred electronic value is usable on a basis of the condition information and controlling a function related to use of the transferred electronic value on a basis of a determination result.

17. An information processing system, comprising:
a first information processing apparatus which is a transfer source of an electronic value; and
a second information processing apparatus which is a transfer destination of the electronic value,
wherein the second information processing apparatus includes
a condition information acquiring unit configured to acquire condition information indicating a use condition of an electronic value transferred from the first information processing apparatus, and
a processing unit configured to determine whether or not the transferred electronic value is usable on a basis of the condition information and control a function related to use of the transferred electronic value on a basis of a determination result.
